(19) United States
(12) Patent Application Publication
(10) Pub. No.: US 2022/0402065 A1
(43) Pub. Date: Dec. 22, 2022

(54) COMPOSITIONS, METHODS, AND SYSTEMS FOR RESISTANCE SPOT WELDING OR BRAZING ALUMINUM TO STEEL

(71) Applicant: OHIO STATE INNOVATION FOUNDATION, Columbus, OH (US)

(72) Inventors: Antonio Ramirez, Columbus, OH (US); Rafael Arthur Reghine Giorjao, Columbus, OH (US); Bryan Lara, Columbus, OH (US)

(21) Appl. No.: 17/846,159

(22) Filed: Jun. 22, 2022

Related U.S. Application Data
(60) Provisional application No. 63/213,323, filed on Jun. 22, 2021.

(51) Int. Cl. B23K 11/20; B32B 15/01; B23K 35/30; B23K 11/18; B23K 11/11

(52) U.S. Cl. CPC B23K 11/20; B32B 15/012; B23K 35/3086; B23K 11/185; B23K 11/115; B23K 2103/05

(57) ABSTRACT

Disclosed herein are compositions, methods, and systems for resistance spot welding or brazing an aluminum member to a steel member using a chromium layer disposed between the aluminum member and the steel member.

### CROSS-REFERENCE TO RELATED APPLICATIONS

This application claims the benefit of priority to U.S. Provisional Application No. 63/213,323, filed Jun. 22, 2021, which is hereby incorporated herein by reference in its entirety.

### STATEMENT OF GOVERNMENT SUPPORT

This invention was made with government support under 1822144 awarded by the National Science Foundation. The government has certain rights in the invention.

### BACKGROUND

The industry increasing demand for dissimilar metals' vehicle body frames has promoted an urgent appeal for optimization in the Al-Steel resistance spot welding scenario. The compositions, methods, and systems discussed herein addresses these and other needs.

### SUMMARY

In accordance with the purposes of the disclosed compositions, methods, and systems as embodied and broadly described herein, the disclosed subject matter relates to compositions, methods, and systems for resistance spot welding or brazing an aluminum member to a steel member using a chromium layer disposed between the aluminum member and the steel member.

Additional advantages of the disclosed compositions, systems, and methods will be set forth in part in the description which follows, and in part will be obvious from the description. The advantages of the disclosed compositions, systems, and methods will be realized and attained by means of the elements and combinations particularly pointed out in the appended claims. It is to be understood that both the foregoing general description and the following detailed description are exemplary and explanatory only and are not restrictive of the disclosed systems and methods, as claimed.

The details of one or more embodiments of the invention are set forth in the accompanying drawings and the description below. Other features, objects, and advantages of the invention will be apparent from the description and drawings, and from the claims.

### BRIEF DESCRIPTION OF THE FIGURES

The accompanying figures, which are incorporated in and constitute a part of this specification, illustrate several aspects of the disclosure, and together with the description, serve to explain the principles of the disclosure.

FIG. 1. Process overview and details.

FIG. 2. Weld configuration for mechanical performance evaluation.

FIG. 3. Al—Fe reaction overview, (A) Reduce the available Al in the system, (B) Decrease the products kinetics formation.

FIG. 4A. Al—Fe-10× phase diagram at a fixed 60% Al composition.

FIG. 4B. Al—Fe-10× phase diagram at a fixed 60% Al composition.

FIG. 4C. Al—Fe-10× phase diagram at a fixed 60% Al composition.

FIG. 4D. Al—Fe-10× phase diagram at a fixed 60% Al composition.

FIG. 4E. Al—Fe-10× phase diagram at a fixed 60% Al composition.

FIG. 4F. Al—Fe-10× phase diagram at a fixed 60% Al composition.

FIG. 5. Al diffusion calculation through a Fe matrix with specific elements additions.

FIG. 6A. Resistance spot weld cross-section: No-interlayer.

FIG. 6B. Resistance spot weld cross-section: Low carbon steel interlayer.

FIG. 6C. Resistance spot weld cross-section: 430 SS interlayer.

FIG. 6D. Resistance spot weld cross-section: 304 SS interlayer.

FIG. 6E. Resistance spot weld cross-section: EBrite SS interlayer.

FIG. 7. Simulated temperatures at the interface for different interlayer conditions.

FIG. 8. Al—Fe phase diagram. Dotted lines indicate the maximum temperatures calculated by the no-interlayer and interlayer welds.

FIG. 9. Simulated spot weld cross-section for different conditions.

FIG. 10. Simulated Al diffusion through different alloys considering the thermal cycle presented in FIG. 7.

FIG. 11A. No interlayer interface regions showing cracking and not-joined regions.

FIG. 11B. 430 SS interlayer weld showing no defects along the join line FIG. 12A. AHSS-Interlayer interface SEM analysis: No-interlayer.

FIG. 12B. AHSS-Interlayer interface SEM analysis: Low carbon steel interlayer.

FIG. 12C. AHSS-Interlayer interface SEM analysis: 430 SS interlayer.

FIG. 12D. AHSS-Interlayer interface SEM analysis: 304 SS interlayer.

FIG. 12E. AHSS-Interlayer interface SEM analysis: EBrite SS interlayer.

FIG. 13A. Al-Interlayer interface EDS analysis: No-interlayer.

FIG. 13B. Al-Interlayer interface EDS analysis: Low carbon steel interlayer.

FIG. 13C. Al-Interlayer interface EDS analysis: 430 SS interlayer.

FIG. 13D. Al-Interlayer interface EDS analysis: 304 SS interlayer.

FIG. 13E. Al-Interlayer interface EDS analysis: EBrite SS interlayer.

FIG. 14A. Tensile shear test results: maximum forces.

FIG. 14B. Tensile shear test results: energy at the peak force for different interlayers conditions.

FIG. 15A. Fracture surface for the AA6022 for the low carbon steel condition. On all conditions evaluated, the interlayer remained attached to the AHSS after the mechanical test.

FIG. 15B. Fracture surface for the AHSS for the low carbon steel condition. On all conditions evaluated, the interlayer remained attached to the AHSS after the mechanical test.

FIG. 15C. Fracture surface for the AA6022 for the 430 SS condition. On all conditions evaluated, the interlayer remained attached to the AHSS after the mechanical test.

FIG. 15D. Fracture surface for the AHSS for the 430 SS condition. On all conditions evaluated, the interlayer remained attached to the AHSS after the mechanical test.

FIG. 16. Schematic diagram of interlayer.

FIG. 17. Welding variables.

FIG. 18. Intermetallic compounds.

FIG. 19. Intermetallic compounds formed.

FIG. 20A. A solidification profile for A-40Fe (baseline), Al-30Fe-10Cu and Al-30Fe-10Cr.

FIG. 20B. Al₃Fe mass fraction of various compositions.

FIG. 20C. Solidification temperature range of various compositions.

FIG. 21. Effect of elements on FeAl₃ Gibbs Free Energy.

FIG. 22. SEM image of the 430 SS interlayer interface.

FIG. 23. SORPAS Thermal History.

FIG. 24. Simulated Al diffusion through different alloys.

FIG. 25. Al-Interlayer interface EDS analysis: (Top panel) 430 SS interlayer, (Middle panel) 304 SS interlayer, and (bottom panel) EBrite SS interlayer.

FIG. 26A. Resistance spot weld cross-section: No-interlayer.

FIG. 26B. Resistance spot weld cross-section: 430 SS interlayer.

FIG. 26C. Resistance spot weld cross-section: 304 SS interlayer.

FIG. 27A. AHSS-Interlayer interface SEM analysis: No-interlayer.

FIG. 27B. AHSS-Interlayer interface SEM analysis: 430 SS interlayer.

FIG. 27C. AHSS-Interlayer interface SEM analysis: 304 SS interlayer.

FIG. 28. GE concept laser M-lab Cusing 500R machine.

FIG. 29. Schematic of additive manufacturing (AM) interlayer printed onto Al.

FIG. 30. Schematic of AM interlayer printed onto steel.

FIG. 31. Images of AM interlayer printing.

FIG. 32. Image of printed AM interlayer.

FIG. 33. Deposition profile of 316L AM interlayer.

FIG. 34. Deposition profile of 430 foil interlayer.

FIG. 35. Tensile shear test results: maximum forces (right axis) and energy at the peak force (left axis) for different interlayers conditions. Error bars—95% CI for 3 tests.

FIG. 36. Al diffusion distance as a function of Cr wt %.

FIG. 37. Literature Comparison.

FIG. 38. Image of results for electroplating Cr on Al.

FIG. 39. Resistance spot weld cross-section for Cr electroplated interlayer.

FIG. 40. Al-Interlayer interface EDS analysis for Cr electroplated interlayer.

FIG. 41. Cr electroplated interlayer interface SEM analysis.

### DETAILED DESCRIPTION

The compositions, methods, and systems described herein may be understood more readily by reference to the following detailed description of specific aspects of the disclosed subject matter and the Examples included therein.

Before the present compositions, methods, and systems are disclosed and described, it is to be understood that the aspects described below are not limited to specific synthetic methods or specific reagents, as such may, of course, vary. It is also to be understood that the terminology used herein is for the purpose of describing particular aspects only and is not intended to be limiting.

Also, throughout this specification, various publications are referenced. The disclosures of these publications in their entireties are hereby incorporated by reference into this application in order to more fully describe the state of the art to which the disclosed matter pertains. The references disclosed are also individually and specifically incorporated by reference herein for the material contained in them that is discussed in the sentence in which the reference is relied upon.

In this specification and in the claims that follow, reference will be made to a number of terms, which shall be defined to have the following meanings.

Throughout the description and claims of this specification the word “comprise” and other forms of the word, such as “comprising” and “comprises,” means including but not limited to, and is not intended to exclude, for example, other additives, components, integers, or steps.

As used in the description and the appended claims, the singular forms “a,” “an,” and “the” include plural referents unless the context clearly dictates otherwise. Thus, for example, reference to “a composition” includes mixtures of two or more such compositions, reference to “an agent” includes mixtures of two or more such agents, reference to “the component” includes mixtures of two or more such components, and the like.

“Optional” or “optionally” means that the subsequently described event or circumstance can or cannot occur, and that the description includes instances where the event or circumstance occurs and instances where it does not.

Ranges can be expressed herein as from “about” one particular value, and/or to “about” another particular value. By “about” is meant within 5% of the value, e.g., within 4, 3, 2, or 1% of the value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

It is understood that throughout this specification the identifiers “first” and “second” are used solely to aid in distinguishing the various components and steps of the disclosed subject matter. The identifiers “first” and “second” are not intended to imply any particular order, amount, preference, or importance to the components or steps modified by these terms.

References in the specification and concluding claims to parts by weight of a particular element or component in a composition denotes the weight relationship between the element or component and any other elements or components in the composition or article for which a part by weight is expressed. Thus, in a compound containing 2 parts by weight of component X and 5 parts by weight component Y, X and Y are present at a weight ratio of 2:5, and are present in such ratio regardless of whether additional components are contained in the compound.

A weight percent (wt. %) of a component, unless specifically stated to the contrary, is based on the total weight of the formulation or composition in which the component is included.

Disclosed herein are methods of resistance spot welding or brazing an aluminum member to a steel member, the aluminum member and the steel member each having a first surface. The methods comprise: forming a workpiece stack by disposing a chromium layer having a first surface and a second surface opposite and spaced apart from the first surface between the aluminum member and the steel member, such that: at least a portion of the first surface of the aluminum member is in physical contact with the first surface of the chromium layer; and at least a portion of the first surface of the steel member is in physical contact with the second surface of chromium layer; and resistance spot welding or brazing the workpiece stack together.

The term “aluminum member” as used herein thus encompasses unalloyed aluminum and a wide variety of aluminum alloys, whether coated or uncoated, in different spot-weldable or brazable forms including wrought sheet layers, extrusions, forgings, etc., as well as castings.

The aluminum member can, for example, comprise unalloyed aluminum or an aluminum alloy. In some examples, the aluminum member comprises an aluminum alloy.

Aluminum alloys comprise aluminum and one or more alloying elements, such as copper, magnesium, and silicon, individually or in combination. The particular alloying elements may be identified by a numbering scheme developed by the Aluminum Association, which designates aluminum alloys by a four-digit code preceded by the prefix AA (for Aluminum Association). The first digit of the four-digit code designates the primary alloying elements with subsequent digits indicating relative concentrations. In many automotive applications, AA6xxx alloys containing magnesium and silicon in varying proportions are preferred. The aluminum member can comprise an aluminum alloy in wrought or cast form. For example, the aluminum member can comprise a 4xxx, 5xxx, 6xxx, or 7xxx series wrought aluminum alloy sheet layer, extrusion, forging, or other worked article. Alternatively, the aluminum member can comprise a 4xxx, 5xxx, 6xxx, or 7xxx series aluminum alloy casting. Examples of aluminum alloys include, but are not limited to, AA5754 and AA5182 aluminum-magnesium alloy, AA6111 and AA6022 aluminum-magnesium-silicon alloy, AA7003 and AA7055 aluminum-zinc alloy, and Al-10Si-Mg aluminum die casting alloy. In some examples, the aluminum member comprises an AA6022 aluminum-magnesium-silicon alloy. The aluminum member can further be employed in a variety of tempers including annealed (0), strain hardened (H), and solution heat treated (T), if desired.

The term “steel member” as used herein comprises a steel substrate, whether coated or uncoated, of a wide variety of different grades and strengths. The steel substrate may be hot-rolled or cold-rolled and may be composed of steel such as mild steel, interstitial-free steel, bake-hardenable steel, high-strength low-alloy (HSLA) steel, dual-phase (DP) steel, complex-phase (CP) steel, martensitic (MART) steel, transformation induced plasticity (TRIP) steel, twining induced plasticity (TWIP) steel, and boron steel such as when the steel member includes press-hardened steel (PHS). In some examples, the steel member comprises an advanced high strength steel (AHSS), such as Usibor 2000® (AlSi coated hot-stamped steel).

In some examples, the aluminum member, the steel member, or a combination thereof comprises at least a portion of a vehicle (e.g., an armored vehicle or an unarmored vehicle), heat exchanger, pipe, or conduit (e.g., for a pipeline). Examples of vehicles include, but are not limited to, wagon, bicycles, motor vehicles (e.g., motorcycles, cars, trucks, buses, etc.), railed vehicles (e.g., trains, trams, etc.), watercraft (e.g., ships, boats, etc.), amphibious vehicles (e.g., hovercraft), aircraft (e.g., airplanes, helicopters, etc.), and spacecraft.

The chromium layer can, for example, comprise chromium in an amount of 1 wt. % or more (e.g., 2 wt. % or more, 3 wt. % or more, 4 wt. % or more, 5 wt. % or more, 6 wt. % or more, 7 wt. % or more, 8 wt. % or more, 9 wt. % or more, 10 wt. % or more, 11 wt. % or more, 12 wt. % or more, 13 wt. % or more, 14 wt. % or more, 15 wt. % or more, 16 wt. % or more, 17 wt. % or more, 18 wt. % or more, 19 wt. % or more, 20 wt. % or more, 21 wt. % or more, 22 wt. % or more, 23 wt. % or more, 24 wt. % or more, 25 wt. % or more, 26 wt. % or more, 27 wt. % or more, or 28 wt. % or more). In some examples, the chromium layer can comprise chromium in an amount of 30 wt. % or less (e.g., 29 wt. % or less, 28 wt. % or less, 27 wt. % or less, 26 wt. % or less, 25 wt. % or less, 24 wt. % or less, 23 wt. % or less, 22 wt. % or less, 21 wt. % or less, 20 wt. % or less, 19 wt. % or less, 18 wt. % or less, 17 wt. % or less, 16 wt. % or less, 15 wt. % or less, 14 wt. % or less, 13 wt. % or less, 12 wt. % or less, 11 wt. % or less, 10 wt. % or less, 9 wt. % or less, 8 wt. % or less, 7 wt. % or less, 6 wt. % or less, 5 wt. % or less, 4 wt. % or less, 3 wt. % or less, or 2 wt. % or less). The amount of chromium in the chromium layer can range from any of the minimum values described above to any of the maximum values described above. For example, the chromium in an amount of from 1 wt. % to 30 wt. % (e.g., from 1 wt. % to 15 wt. %, from 15 wt. % to 30 wt. %, from 1 wt. % to 10 wt. %, from 10 wt. % to 20 wt. %, from 20 wt. % to 30 wt. %, from 5 wt. % to 30 wt. %, from 1 wt. % to 25 wt. %, from 5 wt. % to 25 wt. %, from 1 wt. % to 17 wt. % Cr, from 5 wt. % to 17 wt. %, from 5 wt. % to 26 wt. %, from 10 wt. % to 26 wt. %, or from 10 wt. % to 17 wt. %).

The chromium layer can comprise a chromium alloy. In some examples, the chromium layer can comprise a stainless steel. Examples of stainless steels include, but are not limited to, 430 stainless steel, 304 stainless steel, EBrite stainless steel, 316 stainless steel, austenic stainless steel, ferritic stainless steel, and combinations thereof.

The chromium layer can have an average thickness, the average thickness being the average dimension from the first surface to the second surface. The chromium layer can, for example, have an average thickness of 100 μm or more (e.g., 125 μm or more, 150 μm or more, 175 μm or more, 200 μm or more, 225 μm or more, 250 μm or more, 275 μm or more, 300 μm or more, 325 μm or more, 350 μm or more, 375 μm or more, 400 μm or more, 425 μm or more, 450 μm or more, or 475 μm or more). In some examples, the chromium layer can have an average thickness of 500 μm or less (e.g., 475 μm or less, 450 μm or less, 425 μm or less, 400 μm or less, 375 μm or less, 350 μm or less, 325 μm or less, 300 μm or less, 275 μm or less, 250 μm or less, 225 μm or less, 200 μm or less, 175 μm or less, 150 μm or less, or 125 μm or less). The average thickness of the chromium layer can range from any of the minimum values described above to any of the maximum values described above. For example, the chromium layer can have an average thickness of from 100 μm to 500 μm (e.g., from 100 μm to 300 μm, from 300 μm to 500 μm, from 100 μm to 200 μm, from 200 μm to 300 μm, from 300 μm to 400 μm, from 400 μm to 500 μm, from 125 μm to 500 μm, from 100 μm to 475 μm, from 125 μm to 475 μm, from 100 μm to 400 μm, or from 200 μm to 400 μm).

In some examples, the chromium layer can comprise a foil or sheet.

In some examples, the method further comprises depositing the chromium layer onto the portion of the second surface of the aluminum member, the portion of the first surface of the steel member, or a combination thereof. Depositing the chromium layer can, for example, comprise electroplating, lithographic deposition, electron beam deposition, thermal deposition, spin coating, drop-casting, zone casting, dip coating, blade coating, spraying, vacuum filtration, chemical vapor deposition (CVD), atomic layer deposition (ALD), physical vapor deposition (PVD), sputtering, pulsed layer deposition, molecular beam epitaxy, evaporation, ultrasonic metal welding (UMW), or combinations thereof. In some examples, depositing the chromium layer can comprise thermal spraying (e.g., cold spraying, hot spraying), electroplating, hot dipping, cladding, laser deposition, powder bed additive manufacturing, or a combination thereof.

Resistance spot welding and brazing methods and appropriate parameters therefor are known in the art.

Resistance spot welding the workpiece stack together can, for example, comprises: contacting a first electrode with a location on a second surface of the aluminum member, the second surface of the aluminum member being opposite and spaced apart from the first surface; contacting a second electrode with a location on a second surface of the steel member, the second surface of the steel member being opposite and spaced apart from the first surface; wherein the location on the second surface of the aluminum member and the location on the second surface of the steel surface are aligned such that the first electrode is disposed opposite and spaced apart from the second electrode; applying a current between the first electrode and the second electrode through the workpiece stack; and terminating the application of current.

The applied current can, for example, be 5 kilo Ampere (kA) or more (e.g., 6 kA or more, 7 kA or more, 8 kA or more, 9 kA or more, 10 kA or more, 11 kA or more, 12 kA or more, 13 kA or more, 14 kA or more, 15 kA or more, 16 kA or more, 17 kA or more, 18 kA or more, 19 kA or more, 20 kA or more, 21 kA or more, 22 kA or more, 23 kA or more, or 24 kA or more). In some examples, the applied current can be 25 kA or less (e.g., 24 kA or less, 23 kA or less, 22 kA or less, 21 kA or less, 20 kA or less, 19 kA or less, 18 kA or less, 17 kA or less, 16 kA or less, 15 kA or less, 14 kA or less, 13 kA or less, 12 kA or less, 11 kA or less, 10 kA or less, 9 kA or less, 8 kA or less, 7 kA or less, or 6 kA or less). The applied current can range from any of the minimum values described above to any of the maximum values described above. For example, the applied current can be from 5 kA to 25 kA (e.g., from 5 kA to 15 kA, from 15 kA to 25 kA, from 5 kA to 10 kA, from 10 kA to 15 kA, from 15 kA to 20 kA, from 20 kA to 25 kA, from 6 kA to 25 kA, from 5 kA to 19 kA, from 6 kA to 19 kA, or from 10 kA to 20 kA).

The current can, for example, be applied for an amount of time of 50 milliseconds or more (e.g., 60 milliseconds or more, 70 milliseconds or more, 80 milliseconds or more, 90 milliseconds or more, 100 milliseconds or more, 125 milliseconds or more, 150 milliseconds or more, 175 milliseconds or more, 200 milliseconds or more, 225 milliseconds or more, 250 milliseconds or more, 300 milliseconds or more, 350 milliseconds or more, 400 milliseconds or more, 450 milliseconds or more, 500 milliseconds or more, 600 milliseconds or more, 700 milliseconds or more, 800 milliseconds or more, or 900 milliseconds or more). In some examples, the current can be applied for an amount of time of 1000 milliseconds or less (e.g., 900 milliseconds or less, 800 milliseconds or less, 700 milliseconds or less, 600 milliseconds or less, 500 milliseconds or less, 450 milliseconds or less, 400 milliseconds or less, 350 milliseconds or less, 300 milliseconds or less, 250 milliseconds or less, 225 milliseconds or less, 200 milliseconds or less, 175 milliseconds or less, 150 milliseconds or less, 125 milliseconds or less, 100 milliseconds or less, 90 milliseconds or less, 80 milliseconds or less, 70 milliseconds or less, or 60 milliseconds or less). The amount of time that the current is applied can range from any of the minimum values described above to any of the maximum values described above. For example, the current can be applied for an amount of time of from 50 milliseconds (ms) to 1000 milliseconds (e.g., from 50 milliseconds to 500 milliseconds, from 500 milliseconds to 1000 milliseconds, from 50 milliseconds to 200 milliseconds, from 200 milliseconds to 400 milliseconds, from 400 milliseconds to 600 milliseconds, from 600 milliseconds to 800 milliseconds, from 800 milliseconds to 1000 milliseconds, from 100 milliseconds to 1000 milliseconds, from 50 milliseconds to 950 milliseconds, or from 100 milliseconds to 950 milliseconds).

In some examples, the current is applied in a series of pulses, with each pulse independently having a length of 66 milliseconds or more (e.g., 70 milliseconds or more, 75 milliseconds or more, 80 milliseconds or more, 85 milliseconds or more, 90 milliseconds or more, 95 milliseconds or more, 100 milliseconds or more, 110 milliseconds or more, 120 milliseconds or more, 130 milliseconds or more, 140 milliseconds or more, 150 milliseconds or more, 160 milliseconds or more, 170 milliseconds or more, 180 milliseconds or more, or 190 milliseconds or more). In some examples, the current is applied in a series of pulses, with each pulse independently having a length of 200 milliseconds or less (e.g., 190 milliseconds or less, 180 milliseconds or less, 170 milliseconds or less, 160 milliseconds or less, 150 milliseconds or less, 140 milliseconds or less, 130 milliseconds or less, 120 milliseconds or less, 110 milliseconds or less, 100 milliseconds or less, 95 milliseconds or less, 90 milliseconds or less, 85 milliseconds or less, 80 milliseconds or less, 75 milliseconds or less, or 70 milliseconds or less). The length of each pulse can independently range from any of the minimum values described above to any of the maximum values described above. For example, each pulse can independently have a length of from 66 milliseconds to 200 milliseconds (e.g., from 66 milliseconds to 130 milliseconds, from 130 milliseconds to 200 milliseconds, from 66 milliseconds to 100 milliseconds, from 100 milliseconds to 150 milliseconds, from 150 milliseconds to 200 milliseconds, from 70 milliseconds to 200 milliseconds, from 66 milliseconds to 190 milliseconds, from 70 milliseconds to 190 milliseconds or from 100 milliseconds to 200 milliseconds).

In certain examples, the current is applied in a series of pulses and between each of the pulses the application of current ceases for an amount of time of 10 milliseconds or more (e.g., 15 milliseconds or more, 20 milliseconds or more, 25 milliseconds or more, 30 milliseconds or more, or 35 milliseconds or more). In some examples, the current is applied in a series of pulses and between each of the pulses the application of current ceases for an amount of time of 40 milliseconds or less (e.g., 35 milliseconds or less, 30 milliseconds or less, 25 milliseconds or less, 20 milliseconds or less, or 15 milliseconds or less). The amount of time that the current ceases between each of the pulses can independently range from any of the minimum values described above to any of the maximum values described above. For example, between each of the pulses the application of current ceases for an amount of time of from 10 milliseconds to 40 milliseconds (e.g., from 10 milliseconds to 25 milliseconds, from 25 milliseconds to 40 milliseconds, from 10 milliseconds to 20 milliseconds, from 20 milliseconds to 30 milliseconds, from 30 milliseconds to 40 milliseconds, from 15 milliseconds to 40 milliseconds, from 10 milliseconds to 35 milliseconds, from 15 milliseconds to 35 milliseconds, or from 20 milliseconds to 40 milliseconds).

In some examples, the current is applied in a series of pulses and the series of pulses can comprise two or more pulses (e.g. 3 or more, 4 or more, or 5 or more).

The method can, for example, create a weld or brazed joint that joins the workpiece stack together. In some examples, the weld or brazed joint has improved mechanical performance relative to a weld or brazed joint formed from resistance spot welding or brazing a corresponding workpiece stack in the absence of the chromium layer. For example, the weld or brazed joint can have a higher tensile shear force and/or a higher fracture energy (e.g., as determined using lap-shear tensile testing) relative to a weld or brazed joint formed from resistance spot welding or brazing a corresponding workpiece stack in the absence of the chromium layer.

In some examples, the weld or brazed joint can have a tensile shear force (e.g., as determined using lap-shear tensile testing) of 3 kiloNewtons (kN) or more (e.g., 4 kN or more, 5 kN or more, 6 kN or more, 7 kN or more, 8 kN or more, 9 kN or more, 10 kN or more, 11 kN or more, 12 kN or more, 13 kN or more, 14 kN or more, 15 kN or more, 16 kN or more, 17 kN or more, 18 kN or more, 19 kN or more, 20 kN or more, 25 kN or more, or 30 kN or more). In some examples, the weld or brazed joint can have a fracture energy (e.g., as determined using lap-shear tensile testing) of 0.5 Joules (J) or more (e.g., 0.75 J or more, 1 J or more, 1.25 J or more, 1.5 J or more, 1.75 J or more, 2 J or more, 2.5 J or more, 3 J or more, 3.5 J or more, 4 J or more, 4.5 J or more, 5 J or more, 5.5 J or more, 6 J or more, 6.5 J or more, 7 J or more, 7.5 J or more, 8 J or more, 8.5 J or more, 9 J or more, 9.5 J or more, 10 J or more, 11 J or more, 12 J or more, 13 J or more, 14 J or more, 15 J or more, 20 J or more, 25 J or more, or 30 J or more).

In some examples, the weld or brazed joint comprises an intermetallic compound layer with an average thickness of 3 micrometers (microns, μm) or less (e.g., 2.75 μm or less, 2.5 μm or less, 2.25 μm or less, 2 μm or less, 1.75 μm or less, 1.5 μm or less, 1.25 μm or less, 1 μm or less, 0.75 μm or less, 0.5 μm or less, or 0.25 μm or less). In some examples, the weld or brazed joint comprises an intermetallic compound later with an average thickness of 0.1 μm or more (e.g., 0.25 μm or more, 0.5 μm or more, 0.75 μm or more, 1 μm or more, 1.25 μm or more, 1.5 μm or more, 1.75 μm or more, 2 μm or more, 2.25 μm or more, 2.5 μm or more, or 2.75 μm or more). The average thickness of the intermetallic compound layer in the weld or brazed joint can range from any of the minimum values described above to any of the maximum values described above. For example, the weld or brazed joint can comprise an intermetallic compound layer with an average thickness of from 0.1 μm to 3 μm (e.g., from 0.1 μm to 1.5 μm, from 1.5 μm to 3 μm, from 0.1 μm to 1 μm, from 1 μm to 2 μm, from 2 μm to 3 μm, from 0.25 μm to 3 μm, from 0.1 μm to 2.75 μm, or from 0.25 μm to 2.75 μm).

In some examples, the intermetallic compound layer comprises Al₃Fe, Al₅Fe₂, or a combination thereof. In some examples, the intermetallic compound layer has a reduced amount of Al₃Fe relative to a weld or brazed joint formed from resistance spot welding or brazing a corresponding workpiece stack in the absence of the chromium layer.

Also disclosed herein are workpiece stacks configured for resistance spot welding or brazing, wherein the workpiece stack comprises: an aluminum member having a first surface; a steel member having a first surface; and a chromium layer having a first surface and a second surface opposite and spaced apart from the first surface; wherein the chromium layer is disposed between the aluminum member and the steel member, such that: at least a portion of the first surface of the aluminum member is in physical contact with the first surface of the chromium layer; and at least a portion of the first surface of the steel member is in physical contact with the second surface of chromium layer; and wherein the chromium layer comprises from 1 wt. % to 30 wt. % Cr.

Also disclosed herein are methods of joining a first portion of a vehicle to a second portion of a vehicle using the resistance spot welding or brazing methods disclosed herein (e.g., wherein the aluminum member comprises the first portion of the vehicle and the steel member comprises the second portion of the vehicle).

A number of embodiments of the invention have been described. Nevertheless, it will be understood that various modifications may be made without departing from the spirit and scope of the invention. Accordingly, other embodiments are within the scope of the following claims.

The examples below are intended to further illustrate certain aspects of the systems and methods described herein, and are not intended to limit the scope of the claims.

### EXAMPLES

The following examples are set forth below to illustrate the methods and results according to the disclosed subject matter. These examples are not intended to be inclusive of all aspects of the subject matter disclosed herein, but rather to illustrate representative methods and results. These examples are not intended to exclude equivalents and variations of the present invention which are apparent to one skilled in the art.

Efforts have been made to ensure accuracy with respect to numbers (e.g., amounts, temperature, etc.) but some errors and deviations should be accounted for. Unless indicated otherwise, parts are parts by weight, temperature is in ° C. or is at ambient temperature, and pressure is at or near atmospheric. There are numerous variations and combinations of measurement conditions, e.g., component concentrations, temperatures, pressures and other measurement ranges and conditions that can be used to optimize the described process.

### Example 1—Exploring Interlayer Materials for the Improvement of Resistance Spot Welding of Al to Advanced High Strength Steel (AHSS)

The industry increasing demand for dissimilar metals' vehicle body frames has promoted an urgent appeal for optimization in the Al-Steel resistance spot welding scenario. Research groups have explored parameter selection, electrode geometry, and materials combination to enhance the challenging dissimilar metal welds' mechanical performance. From all procedures, the use of interlayers to control the Al—Fe intermetallic formation has gained considerable attention. The purpose of the present work is to explore selected interlayers' effect on resistance spot welding of aluminum and advanced high strength steel. In-depth Calphad calculations were carried out to determine the best candidates to control the Al—Fe intermetallic layer. Cr was selected as a potential candidate due to its capacity to diminish the Al diffusion and low secondary phases formation potential. 300-micron stainless steel interlayers with different Cr contents were selected, and the results were compared. Reduced intermetallic layer and better mechanical performance were achieved in stainless steel interlayers; however, differences in Cr content above 17% did not provide significant performance differences

Introduction.

The automotive industry has been exploring the application of next-generation advanced high strength steel (AHSS) within multi-material joints in recent Body-In-White designs. Such combinations align with the industry goals to reduce vehicle weight for increased fuel efficiency and reduced carbon emissions.

Steel to aluminum joining has been explored by several methods, including solid-state welding (e.g., ultrasonic spot welding (USW) [1], friction stir welding (FSSW) [2-4], and vaporizing foil actuator welding (VFAW) [5]). However, resistance spot welding (RSW) is still considered the primary joining process for sheet components over the last decades due to its low cost, high efficiency, and automation ease.

Due to iron's low solubility in aluminum, a thick and brittle intermetallic compound (IMC) layer can form at the fusion weld interface. The intermetallic compound layer results from a reaction between Al and Fe and serves as the bond between the two materials [6,7]. If not well controlled (distribution and morphology), it deteriorates the weld's load-bearing capacity, this is because the brittle nature of the IMC layer [8, 9].

Several studies have focused on characterizing the interface generated by the resistance spot welding process between aluminum and steel. The studies focused on the characterization of IMC composition, morphology, growth kinetics, and mechanism. Wan et al. [6] observed the existence of a two-layered IMC structure at the interfaces of a steel substrate and Al coating: the Al₅Fe₂ phase adhering to the steel with a tongue-like morphology and the Al₃Fe phase adhering to the Al in a serrate-like morphology. These two phases' growth is controlled by inter-diffusion after a non-parabolic initial transient period [6,7]. The Al₃Fe reaction occurs initially between liquid Al and solid steel, while Al₅Fe₂ layer at the periphery of the interfacial area is a mixture of Al₃Fe and Al [6]. The IMC layer's thickness distribution and morphology directly affect the Al-Steel joint's mechanical strength and failure mode. Miyamoto et al. [10] reported that a strong joint could be obtained when the IMC layer was discontinuous or had a thickness of less than 2 μm and was composed of fine grains in diameter less than 500 nm

To control the Al—Fe intermetallic formation, several authors have been placing an insert (also referred to as interlayer or transition material) between the Al and steel sheets [11-14]. The interlayer's purpose is to provide a controlled transition between aluminum and steel, avoiding/mitigating the undesirable Al—Fe IMC formation. The current interlayer applications in the RSW process are thin foils, hot-dipping, cladding, and thermal spray [7, 12].

Zhang et al. [11] used AA4047 (AlSi₁₁₂) as an insert to improve the weldability between H220YD galvanized high strength steel and 6008-T66 aluminum. The author observed the IMC layer reduction from 1.8 μm to 0.6 μm as the insert thickness increased from 100 μm to 400 μm. Lu et al. [12,13] explored possibilities combining ultrasonic spot welding with AA6061-T6 and 316 Stainless Steels (SS) (0.125 and 0.25 mm) as interlayers. The author reported sound mechanical properties using the 316 SS, with a high lap shear strength of 5 kN, fracture energy of 2.9 J, and button pullout failure mode. The USW step was responsible for improvements in peak strength and fracture energy due to the IMC thickness's reduction. Ibrahim et al. [14] investigated the effect of an 80-μm-thick Al—Mg alloy interlayer on AA6061-T6 to AISI 304 austenitic stainless steel resistance spot welds. Under the same welding condition, Al/steel dissimilar welds with interlayer exhibited higher tensile shear force than those without interlayer.

Although the interlayer method promoted improvements in the joint's mechanical performance, lack of metallurgical study in the interlayer possibilities is still present in the resistance spot welding scenario. An important source for information available is aluminum hot-dipping processes—the molten aluminum reaction with solid steel is a good approximation for RSW. Yin et al. [15] examined the effect of Si content in molten Al on the growth kinetics of Al₅Fe₂ and discovered that the growth factor was reduced with the Si content increase at a fixed reaction temperature, which means Si restrained the growth of Al₅Fe₂. A similar result was found by Cheng et al. [16] and Cheng et al. [17]. Cheng et al. [18] explored the effect of chromium content in the steels on forming the intermetallic phases in the aluminide coatings. Chromium from the steels retarded the interdiffusion between steels and pure aluminum bath, which resulted in a decrease of the intermetallic layer thicknesses and the planarization of the intermetallic layer/steel interfaces. The phase constitutions of the aluminide coatings remained the same, regardless of the steels' chromium content. The intermetallic layers were composed of an outer minor Al₃Fe and an inner major Al₅Fe₂. Yousaf et al. [19] explored Cu content's effect in the intermetallic layer's growth and morphology (Al₅Fe₂). The addition of 11% Cu by weight in pure Al can reduce the thickness of the intermetallic layer up to 75%. The is attributed to the formation of tetragonal intermetallic phases of Al₂Cu and Al₇Cu₂Fe in the outer coating of the aluminized specimen.

In the present study, interlayer candidates were explored to control the intermetallic layer formation and improve the mechanical properties of AHSS to Al 6022 resistance spot welds. The study is divided into three parts. In part one, an in-depth investigation of the Al activity and diffusivity properties for several materials combinations was performed using a CalPhad analysis in order to select the elements with the most impact in the intermetallic formation. In part two, the selected material interlayer was resistance spot welded and its characteristics evaluated. Lastly in part 3, electron microscopy and mechanical testing were used to evaluate the joints characteristics.

Experimental Procedure

Spot welding was conducted using a Medium Frequency Direct Current (MFDC) resistance spot welder equipped with a servo-driven force system available at the Edison Joining Technology Center. The base materials were a 2 mm-6022-T4 Aluminum alloy and a 1.6 mm-AHSS (USIBOR® 2000—Provided by ArcelorMittal). The chemical composition of the base metal sheets are listed on Table 1. The following spot welding multi-stack setup was performed for all experiments: 6022 Aluminum alloy, interlayer, and AHSS. Facing the Al sheet was a F-type, flat electrode with a 16 mm face diameter and a 3 mm radius; facing the steel sheet was a B-type, dome-shaped electrode. Details can be seen in FIG. 1.

TABLE 1
Chemical composition of the base metals.

| # | C | Si | Mn | Mg | Zn | Cr | Ti | Ni | Al | Fe |
|---|---|---|---|---|---|---|---|---|---|---|
| AHSS | 0.37 | 0.7 | 1.4 | — | — | 0.7 | — | — | 0.05 | Bal |
| 6022 | — | 1.0 | — | 0.6 | 0.25 | — | 0.15 | — | Bal | — |

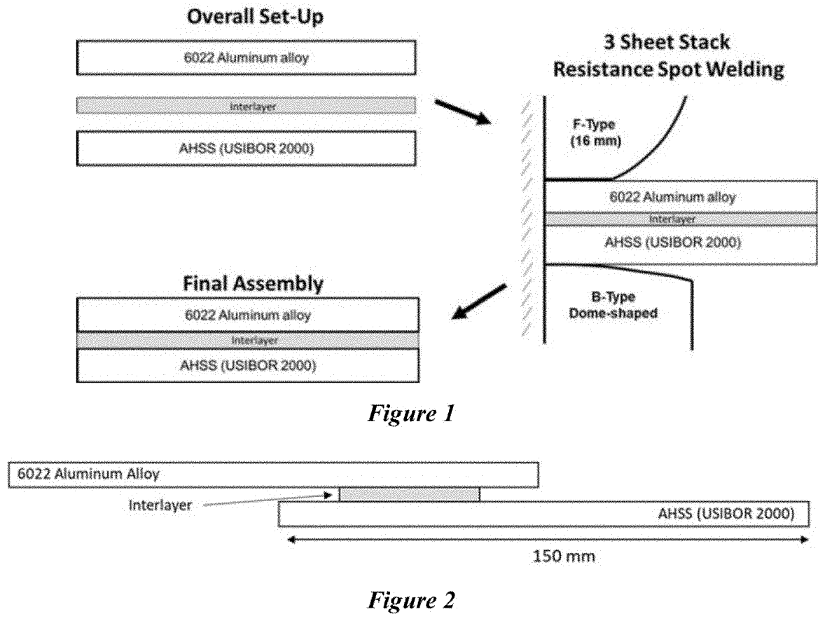

Materials sheets were cut into the dimensions of 150 mm×50 mm, and the overlap length was set to 45 mm, as seen in FIG. 2. The weld profile included a 3-pulse, with a maximum current reaching 16 kA. The weld time for each of the three pulses was 166 ms. A cool time of 30 ms was implemented to minimize electrode wear. The weld force selected was 1000 lbf constant during the entire process.

Finite Element Modeling

A multi-physics process model was established in SORPAS® software to simulate the Al-Steel resistance spot welding process's thermal and mechanical aspects. The model calculated the temperature history at the Al-Steel interface, which is critical for predicting the IMC growth. The details of the model general equations are available in the literature [20,21]. The simulation included a 2D model; the geometry was discretized using 8-noded re-reduced integration brick elements (C3D8R). The steel, aluminum, and interlayer sheets were modeled using distinct mesh regions.

Sample Preparation

The samples were prepared following metallography standard procedures. The welded coupons were cross-sectioned along the weld centerline, and the cross-sections were then cold-mounted with epoxy. The samples were ground with sandpapers, polished with diamond pastes, and finished with a vibratory polish using 0.05 μm colloidal silica. For observation of the IMCs at Al to steel interface, un-etched samples were analyzed in a FEI Apreo scanning electron microscope (SEM) with energy-dispersive X-ray spectroscopy (EDS).

Mechanical Performance

The mechanical performance of welds was evaluated by lap-shear tensile testing in an MTS 810 testing machine per American Welding Society (AWS) Standard D8.9M. For each welding condition, a set of three repeats were tested under a quasi-static loading condition with a displacement rate of 1 mm/min. The fracture energy was calculated by the area under the load-displacement curve till the peak load.

Interlayer Material Selection

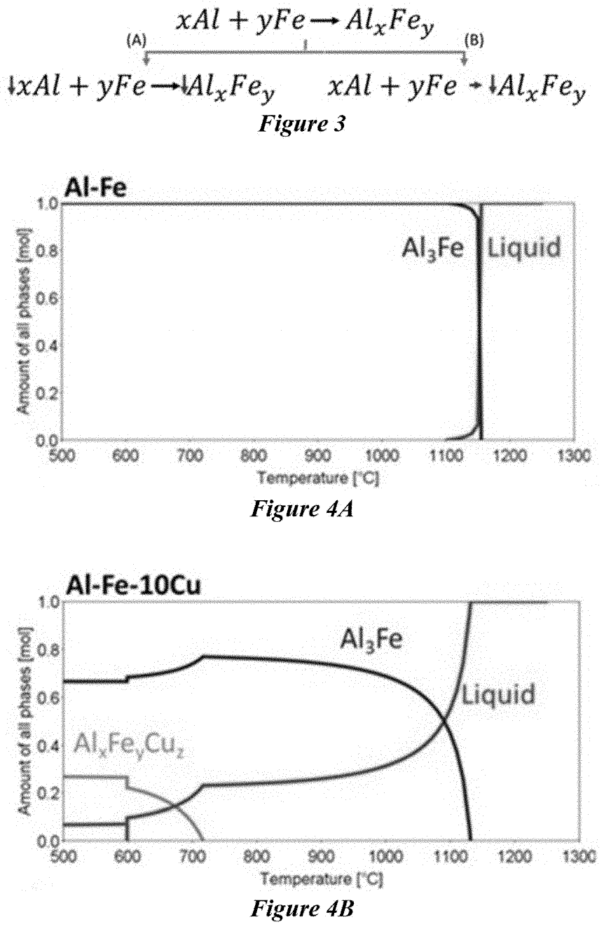

A detailed study on interlayer materials possibilities was conducted as the first step. To reduce/mitigate the undesirable Al—Fe IMC, a better understanding of the reaction that leads to its formation is desirable. In a chemical reaction, the reactants are converted to different substances referred to as reaction products. FIG. 3 shows the Al—Fe reaction in a Al—Fe matrix. The plus sign indicates that iron reacts with aluminum. The arrow indicates that the reaction “forms” Al—Fe phases. In order to control the reaction and reduce/mitigate product formation, two methods were evaluated: (A) Reducing the available Al in the system and (B) reducing the product formation kinetics.

Option (A) includes providing elements to react preferentially with the aluminum, avoiding reacting with the Fe atoms. This approach's drawback is providing other types of Al-based intermetallics, which could also be detrimental for mechanical performance.

Option (B) reduces the product formation kinetics by decreasing the Al activity and diffusivity in the system. As similar to option (A), this approach reduces product formation and also suppresses any other undesirable IMC formation.

The formation and growth characteristics of Fe based aluminide diffusion layers at the Fe—Al interface have been analyzed in terms of interfacial interaction potentials based on the statistico-thermodynamical theory of multicomponent alloys by Akdeniz et al. [22]. The results show that certain impurity elements affect the activity coefficient of Al atoms. Those elements can be classified into two groups:

Group I-impurity elements: Si, Ti, Ge, Sb, Mg, Cu, Ca, Ag, Cd, and Cr, which decrease the activity coefficient of Al atoms, reduce the thickness of the Fe—Al intermetallic diffusion layer; and

Group II-impurity elements: Co, Zn, Mn, Ni, Pb, and Bi, which increase the activity coefficient of Al atoms, tend to increase the thickness of the diffusion layer at the Fe—Al interface.

Results from earlier studies have determined certain elements and the degree to which they effect the IMC layer formation. Dangi et al. [23] studied growth kinetics of intermetallic layers formed at the interface between aluminum alloy 6061 and iron containing Si, Mn and Ni. Silicon in iron was found to be the best for reducing the intermetallic layer's growth, followed by nickel and manganese, respectively. As mentioned before, Cheng et al. [18] explored the effect of chromium content in the steels on forming the intermetallic phases in the aluminide coatings. Chromium from the steels retarded the interdiffusion between steels and pure aluminum bath, which resulted in a decrease of the intermetallic layer thicknesses and the planarization of the intermetallic layer/steel interfaces.

Phase diagrams and diffusion calculations were performed using the commercial thermodynamic software package ThermoCalc 2020a with the following databases: Al database TCAL6, and steel/Fe database TCFE10.

Results

Interlayer Material Exploration

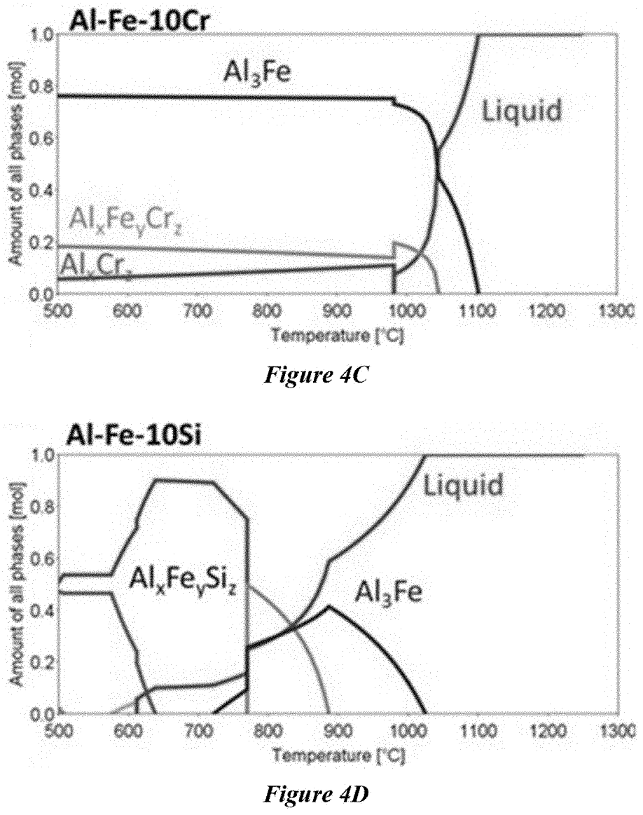

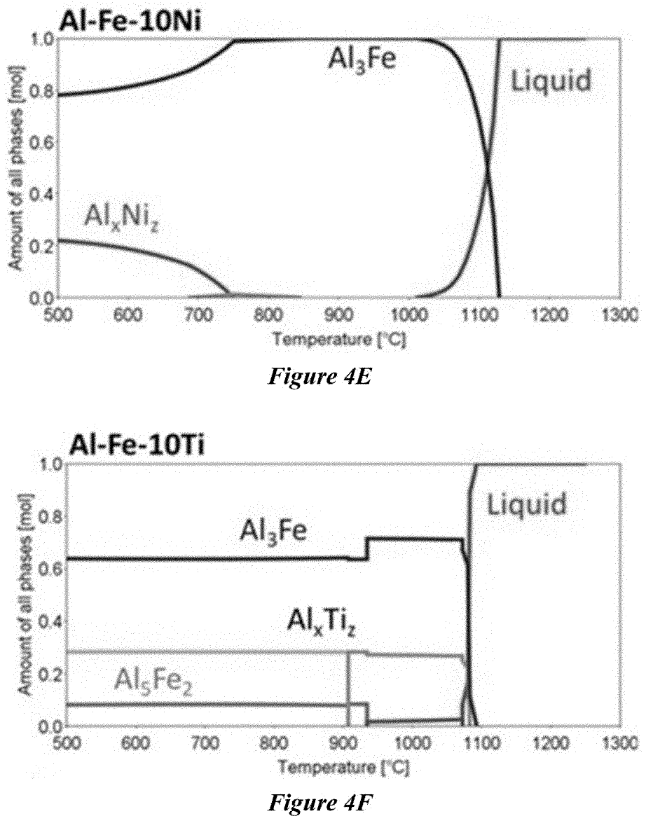

The effect of several elements in Al—Fe system was evaluated Using CalPhad. For the simulation, an Al—Fe—X system was considered, where X indicates a new element explored. In FIG. 4A-FIG. 4F, the Al₃Fe formation on a base Al—Fe system was compared to the systems with additions of Cu, Cr, Si, Ni and Ti.

In the baseline condition indicated in FIG. 4A, all liquid solidifies into the Al₃Fe phase starting at 1175° C. For the best element selection, several aspects were considered, such as reducing the Al₃Fe amount, liquid phase extension, the quantity of other intermetallic generated, and the ability to reduce Al diffusion.

All elements explored were able to reduce the amount of Al₃Fe during solidification, however, there are a number of important differences. Ni was only able to reduce it below 700° C. Cu and Si extended the liquid phase to almost 600° C. Liquid phase extension is associated with joint solidification cracking susceptibility. Solidification cracking occurs in metals when intergranular liquid films rupture within the semisolid region that forms as solidification progresses. Solidification cracking is often associated with the alloy's solidification temperature range: the longer the liquid phase, the higher is the alloy's cracking susceptibility [24]. All elements promoted the appearance of secondary IMC phases. Although Ti presents a rapid liquid decomposition, the pair Al—Ti is known for its exothermic reaction during heating [25], disturbing the determined RSW parameters approach for this study.

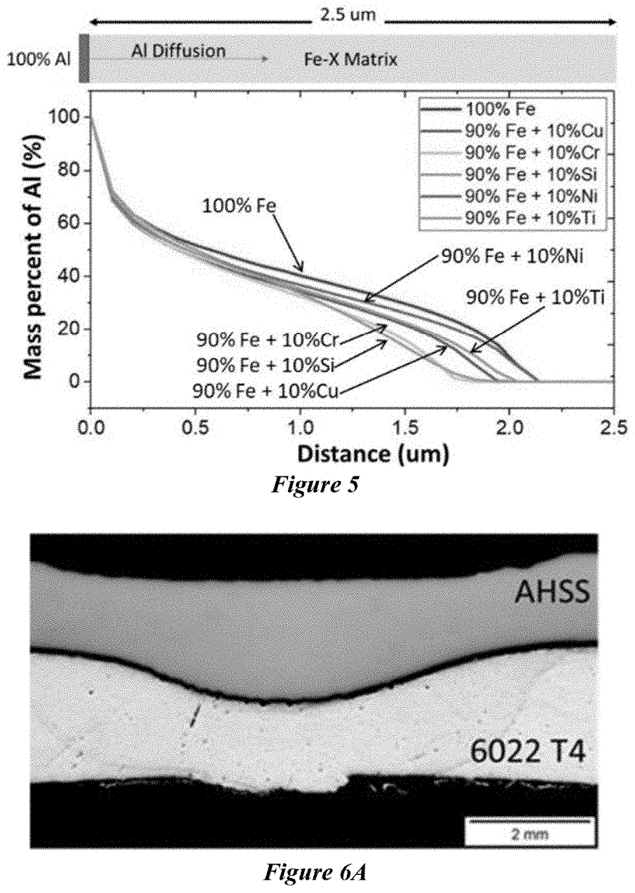

To measure the effects of interlayer composition on IMC growth, a diffusion study was also performed, as seen in FIG. 5. The conditions set was the left border providing Al to the Fe—X system, presenting 2.5 μm in length. The conditions set were 950° C. for 0.6 seconds, a temperature profile similar to the calculated by the simulations presented in the next sections. The results indicate that, compared to the baseline (100% Fe matrix), the addition of 10% Cr and Si were able to reduce the Al diffusion through the iron matrix. A minor influence was observed using Ni, as demonstrated in the works of Akdeniz et al., [22].

Despite reducing the amount of intermetallic generated, high contents of Si in steels are considered detrimental. Embrittlement (loss of a material's ductility) is observed when the silicon additions on steels exceed about 2 wt. % [26].

Cr usually does not present issues in steels, as observed in Stainless Steels containing 18 to 30% Cr in weight. Analysis presented by Qin et al. [27] in RSW and Dybkov [28] in Al hot dipping reveals that a small quantity of Cr and Ni are contained in the Al—Fe phases. Reaction products are solid solutions based upon the Al₃Fe and Al₅Fe₂ and expressed as Al₃(Fe, Cr, Ni) and Al₅(Fe, Cr, Ni)₂. Following the established criteria, Cr has shown the highest potential to reduce the Al—Fe IMC formation without significant drawbacks.

Several methods were considered to add Cr as an interlayer: foils, coating, and laser deposition. For this work, foil interlayers were applied. As Cr foils are not widely available due to their extensive cost, alloys containing high Cr contents were chosen as candidates. 430 Stainless steel (SS) presenting 16% Cr, 304 Stainless Steel, a standard “18/8” (Cr/Ni) stainless, and EBrite Stainless steel, a super ferritic stainless steel containing up to 27% Cr in its composition. Ni's presence on 304 will also be evaluated and compared to the results present in the previous section. Low carbon steel was used as a baseline for comparison purposes.

Three thicknesses were evaluated: 50 μm, 300 μm and 500 μm. Only 300 μm produced sound welds and thus for the purpose of this study, results for an interlayer thickness of 300 μm will be presented. According to its supplier, the composition of each interlayer is presented in Table 2 (McMaster-Carr Supply Company).

TABLE 2
Interlayers chemical composition

| Alloy | C | Cr | Ni | Si | Mn | Al | Fe |
|---|---|---|---|---|---|---|---|
| Low Carbon Steel | 0.09 | 0.03 | 0.01 | 0.009 | 0.35 | — | Bal |
| 430 Stainless Steel | 0.09 | 17 | 0.05 | 0.05 | 1 | — | Bal |
| 304 Stainless Steel | 0.08 | 18.5 | 9 | 0.05 | 1 | — | Bal |
| EBrite Stainless Steel | 0.01 | 27.5 | 0.5 | 0.4 | 0.4 | — | Bal |
| (ASTM XM-27) | | | | | | | |

Joining Process

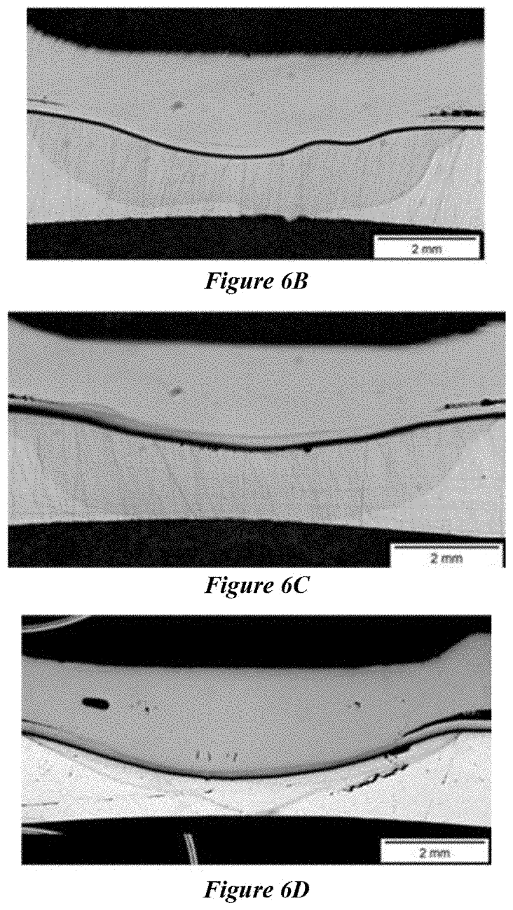

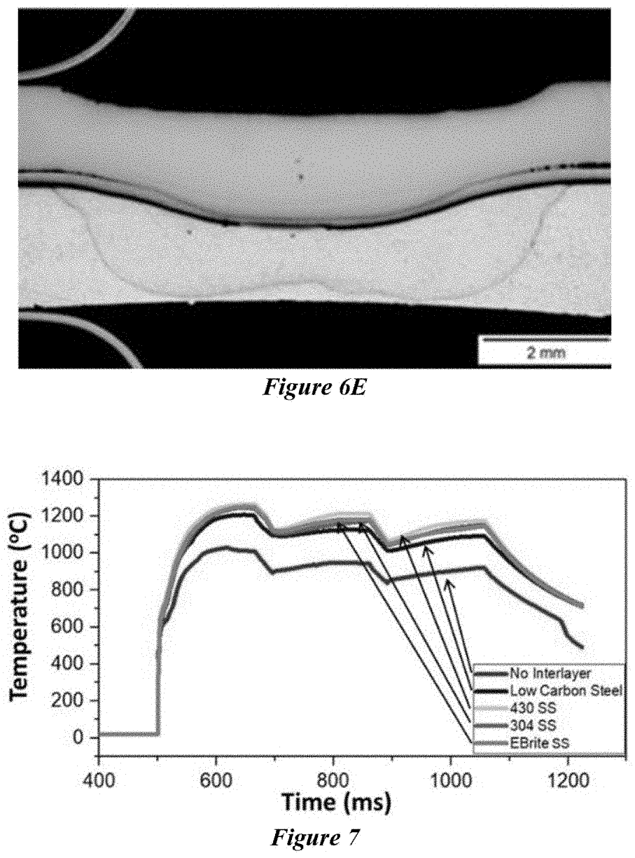

In FIG. 6A-FIG. 6E, successful cross-sections of Al-Interlayer-AHSS are presented. Visually, no significant difference between joints is observed. All welds shared a similar characteristic: two nuggets on base materials separated by an unmelted interface. The first nugget was formed at the Al, featuring molten Al nugget spread on the interlayer. The second nugget was formed inside the base AHSS sheet. As no nugget was formed between materials, a “nugget diameter” was defined by the Al nugget. According to the mentioned criteria, the diameter varied between 9.2 and 9.4 mm.

The Effect of Interlayers on the Welds Thermal Profile

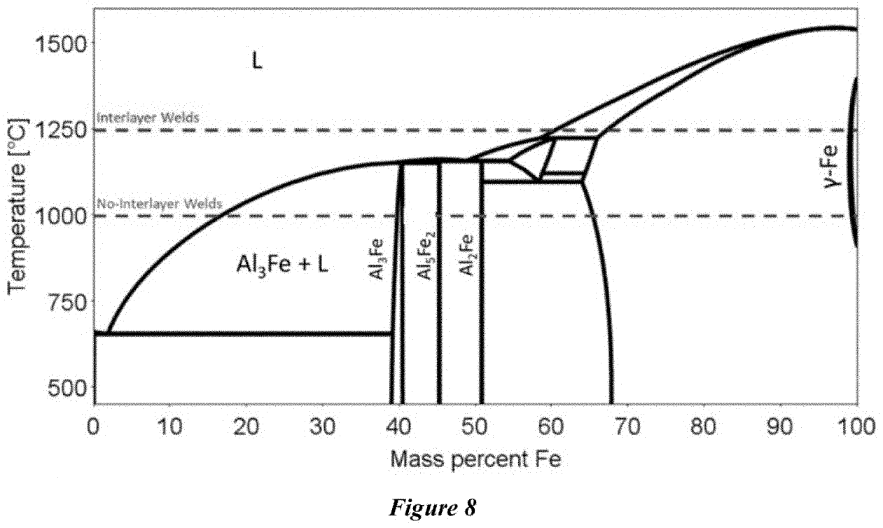

Thermal profiles were obtained through numerical simulations using SORPAS software [20,21], as seen in FIG. 7. The simulated cross-sections matched satisfactory with the experimental data, as observed nugget diameter comparison in Table 3. According to the simulations, the no-interlayer condition presents a lower temperature compared to the interlayered welds. Temperatures around 1000° C. were calculated for the no-interlayer scenario and temperatures around 1250° C. for the interlayer trials. The reason for this behavior was caused by the increased heat generated from the interlayers' additional contact resistance. According to the Al—Fe phase diagram (FIG. 8), the no-interlayer weld may experience weak bonding due to the system's lower temperatures.

TABLE 3
Experimental and simulated nugget diameters

| # | Experimental (mm) | Simulated (mm) |
|---|---|---|
| No-Interlayer | 9.2 | 10.2 |
| Low Carbon Steel | 9.4 | 11 |
| 430 SS | 9.4 | 11 |
| 304 SS | 9.2 | 10.9 |
| EBrite SS | 9.3 | 10.9 |

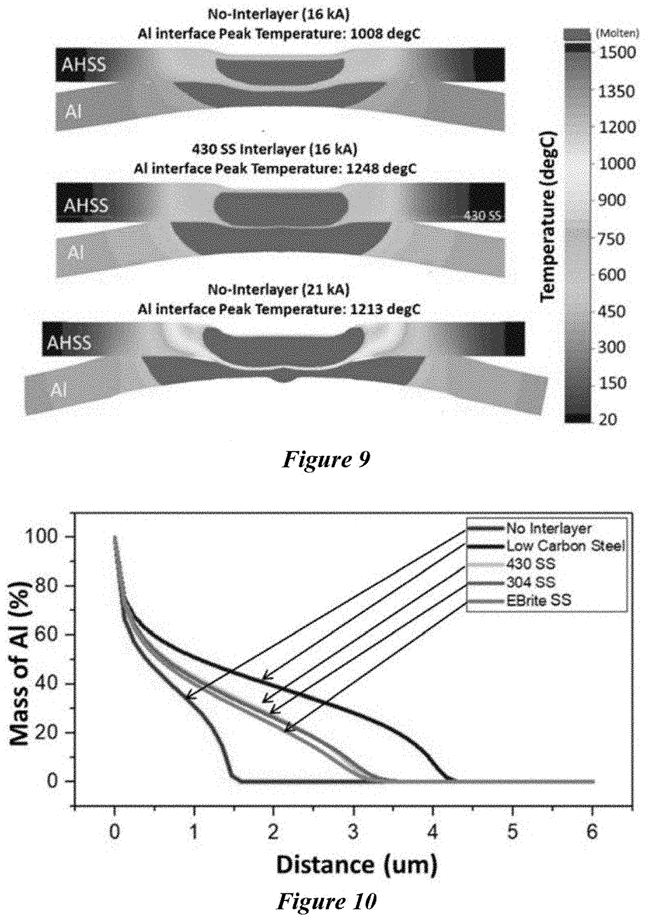

Achieving higher temperatures on the no-interlayer conditions would not be possible without causing significant weld morphology changes. To increment the temperature on the no-interlayer condition, a current increase to 25 kA would be necessary; however, melting on the electrodes and considerable deformation could happen as well, as seen in FIG. 9. Furthermore, the detrimental effects of sheet thinning caused from electrode indentation on mechanical performance is well established. In that way, it is necessary to state that interlayers promote not only chemical changes in the interface but new temperature conditions, not achievable without them.

A new diffusion study using CalPhad was provided, but now using the interlayer's composition in contact with the Al and the calculated temperature profiles from SORPAS. According to FIG. 10, the no-interlayer provided lower Al diffusion into the steel due to its temperature. Both stainless steels showed similar results, as Al reaching 3 μm. The Low Carbon Steel showed the most Al diffusion from all conditions due to its high temperature and lack of Al diffusion retardants.

Characterization

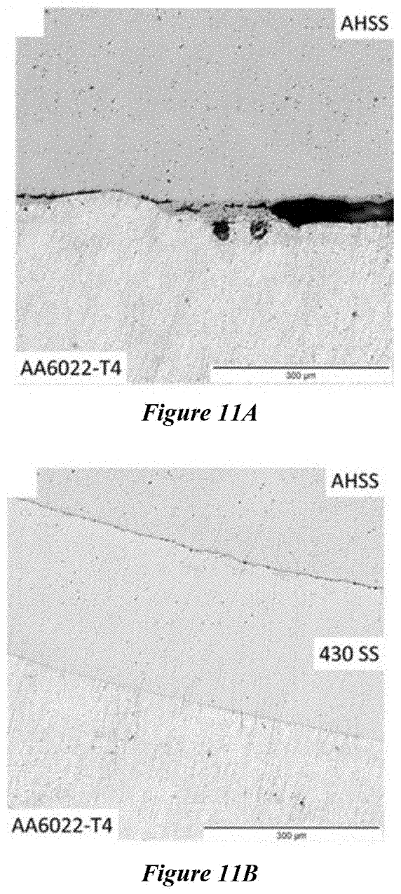

Low diffusion of Al is desirable to avoid the intermetallic formation; however, a lack of it could result in poor bonding between alloys. As illustrated in FIG. 11A-FIG. 11B, the no-interlayer interface shows several regions without bonding, which causes poor mechanical performance. Such behavior was expected, as demonstrated in the temperature simulation analysis shown in FIG. 7 and FIG. 9. As observed in the literature, the link between IMC thickness and mechanical performance is obvious. An IMC layer thickness exceeding 2 μm can deteriorate the strength of the joint. But a distinction must be made regarding whether an IMC layer is completely undesirable. There is a growing body of evidence to support the need for a thin IMC to guarantee the bonding between these alloys [8-10].

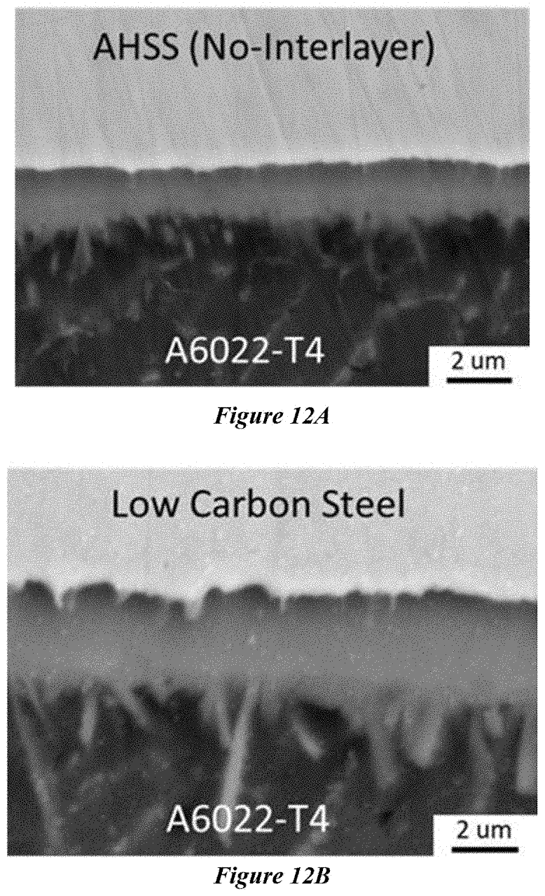

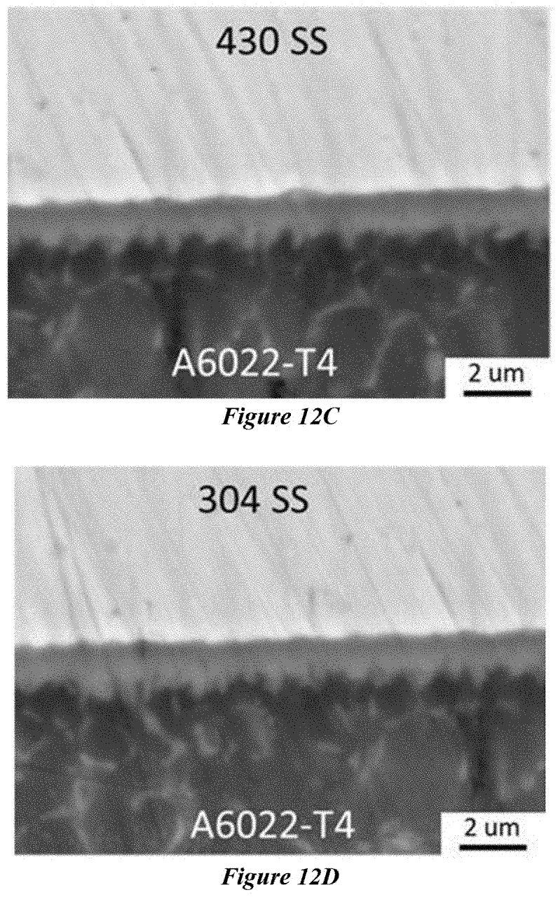

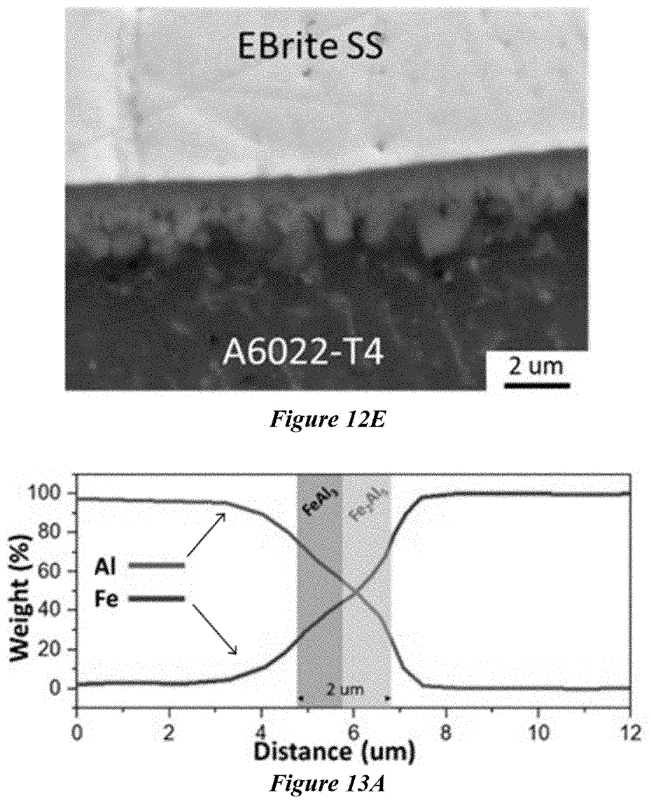

In FIG. 12A-FIG. 12E, the Al-interlayer interface between materials is presented. A relatively flat interface existed between IMCs and steel, whereas needle-like shaped IMCs grew into the Al insert. Such morphology is similar to that observed in direct resistance spot welding of Al to steel [6,29]. The continuous IMC layer thickness differed for each interlayer: 2 μm for No-Interlayer, 3 μm for Low Carbon Steel, 1.1 μm for 430 SS, 1.1 μm for 304 SS, and 1.3 for the EBrite SS. The Ni presence in 304SS did not provide any significant changes in the layer's thickness or morphology, as previously suggested by Calphad analysis. The diffusion and IMC thickness on the no-interlayer condition differed from the previous calculations. It is suggested that bonded regions experienced higher current density due to the presence of cracks in other regions, as seen in FIG. 11A-FIG. 11B. The higher energy density promoted higher Al diffusion and IMC formation on such welds.

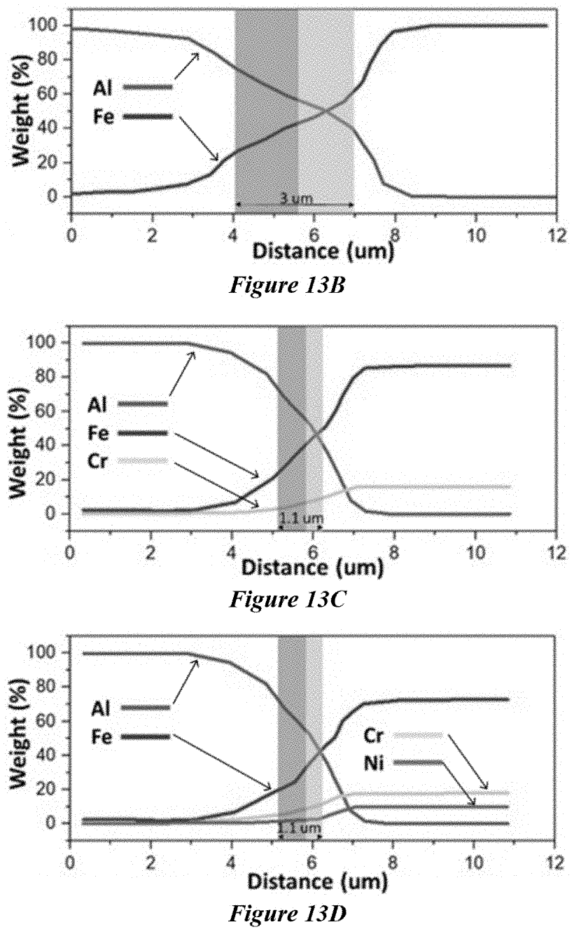

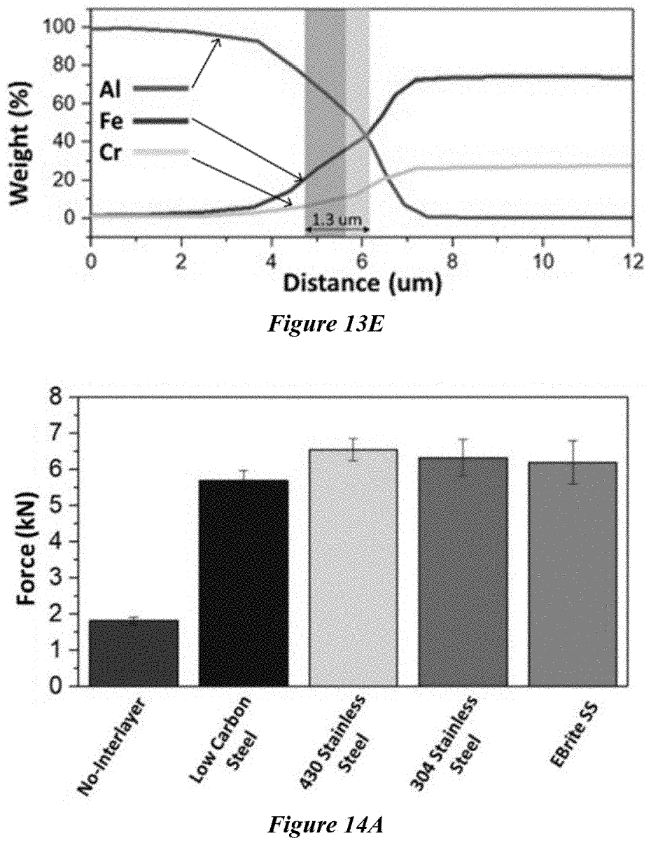

The composition EDS profiles across the interface are plotted in FIG. 13A-FIG. 13E. The Al and Fe distribution indicates that the Al diffusion study in FIG. 10 could accurately represent the material behavior during the welding process. The composition data suggest that the IMC layer includes Al₅Fe₂ adjacent to the steel side and Al₃Fe next to the Al side, as indicated on the composition plots. Both Al₃Fe and Al₅Fe₂ regions changed in size according to the Al diffusion conditions. Also, both IMC layer dimensions suggested by EDS match accurately with the measurements in FIG. 12A-FIG. 12E. The results also clearly state the Cr content has a limit related to its effect on controlling the IMC layer thickness: the 27.5% Cr on the EBrite interlayer could not significantly change the IMC layer thickness. Besides the Cr effect on Al diffusion, it's correct to state the reduction in Fe availability in the reaction front also promoted less formation of IMC, without the formation of new intermetallics, as demonstrated by Qin et al. [27] in RSW and Dybkov [28] in Al hot dipping.

Mechanical Performance

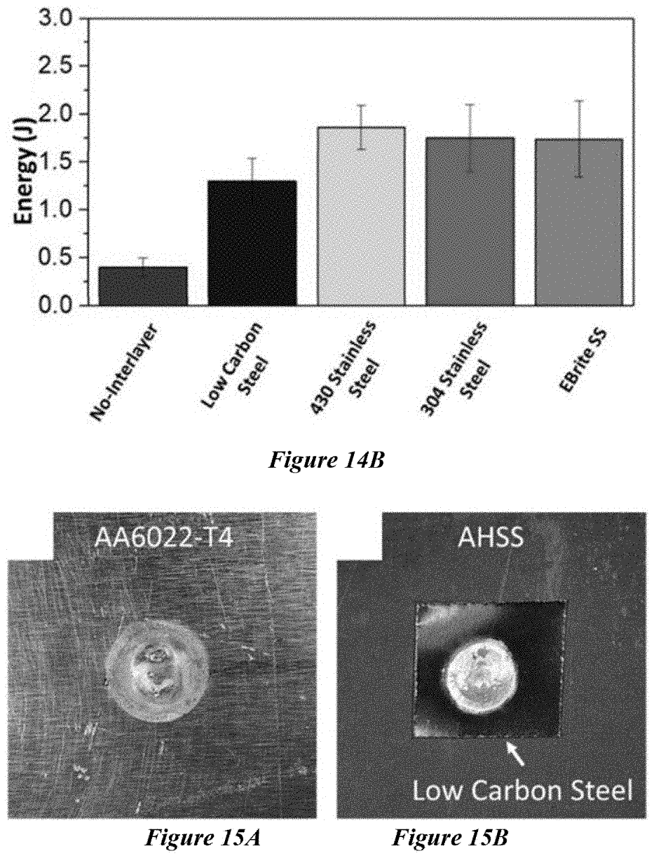

Mechanical tests were performed to evaluate the effect of the interlayer materials on the resistance spot welds performance. According to FIG. 14A-FIG. 14B, 430 SS, 304 SS, and EBrite SS showed the best peak force and fracture energy results. There is a strong relationship between mechanical performance and interlayers with/without Cr wt. %. The average force was around three times larger than the no-interlayer condition. No significant difference was observed between the three stainless steels evaluated. The low carbon steel showed better results compared to the no-interlayer but lower than the stainless steel. The low carbon steel results suggest that the mechanical performance of the weld had two critical factors: 1) the amount of energy delivered to the interface producing a sufficient joining between materials—represented by the difference in the no-interlayer and low carbon maximum values, and 2) the Cr effect on controlling the Al diffusion, represented by the increment observed in the Fe—Cr alloys. As suggested in the IMC thickness and Al diffusion analysis, the difference in Cr content between 430 SS (17%), 304 SS (18.5%), and Ebrite SS (27.5%) did not promote mechanical performance variations.

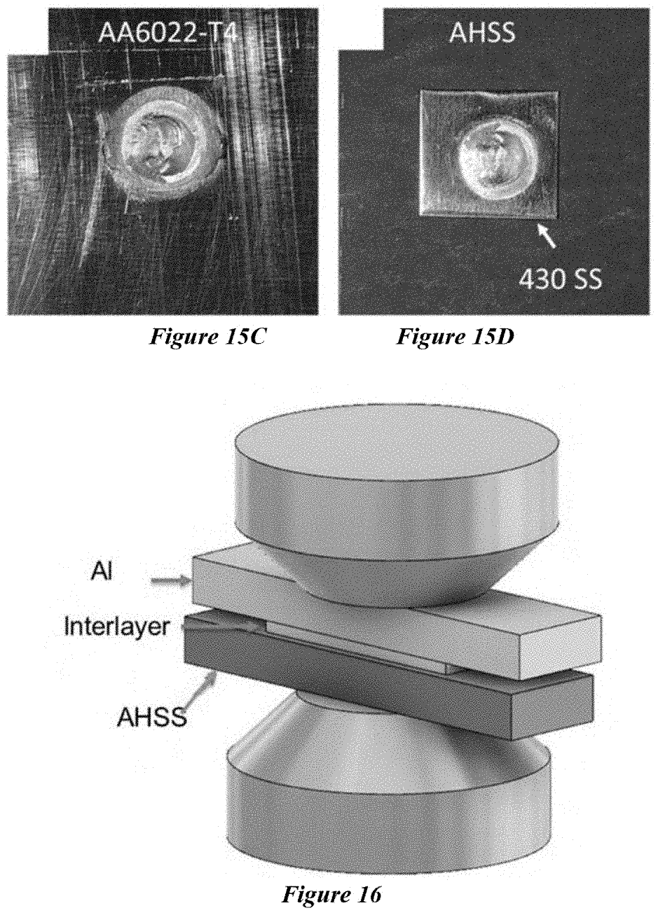

All fracture modes in the present study were interfacial, as seen in FIG. 15A-FIG. 15D. After the mechanical tests, the interlayer always remained attached to the AHSS, suggesting the bonding pair Al-Interlayer being the weakest compared to the Interlayer-AHSS.

According to the literature, interfacial failure modes typically show lower force and energy absorption values than button pull fractures. In view of this, it is important to reiterate the effects of RSW parameters (weld force, current, time), sheet thickness, and interlayer selection (material and thickness) on fracture behavior. The present interfacial failure mode suggests that the present methodology has room for significant improvement, especially related to the RSW parameter selection.

Conclusions

To summarize, resistance spot welding of aluminum and AHSS using an interlayer approach was successful in producing a superior joint when compared to a no interlayer combination. The main points are:
In-depth calculation using CalPhad suggested that Cr was able to reduce the Al diffusion through the Fe matrix. 430 SS, 304 SS and EBrite SS (ASTM XM-27) stainless steel alloys 300 μm foils were chosen to evaluate the Cr content's effect on IMC formation and mechanical performance.
Simulations and experimental data showed that interlayers promoted chemical changes in the interface and new temperature conditions. Temperatures around 1000° C. were calculated for the no-interlayer scenario and temperatures around 1250° C. for the interlayer trials due to its additional contact resistance. Due to its lower temperature, the no-interlayer interface showed several regions without bonding, producing poor mechanical performance.
A continuous IMC layer thickness was observed on all conditions, differing on its thickness: 2 μm for No-Interlayer, 3 μm for Low Carbon Steel, 1.1 μm for 430 SS, 1.1 μm for 304 SS, and 1.3 μm for the EBrite.
The presence of Ni in 304SS did not provide any significant changes in the layer's thickness or morphology, as previously suggested by Calphad analysis.
The diffusion and IMC thickness on the no-interlayer condition differed from the previous calculations. It is suggested that bonded regions experienced higher current density due to the presence of cracks in other regions.
The mechanical performance revealed the beneficial effect of Cr. However, the Cr content variations between the stainless steel alloys did not result in mechanical performance differences. The results suggest that values over 17% Cr may not provide significant benefits in mechanical performance.

### REFERENCES

[1] Macwan A, Kumar A, Chen D L. Ultrasonic spot welded 6111-T4 aluminum alloy to galvanized high-strength low-alloy steel: Microstructure and mechanical properties. Mater Des 2017; 113:284-96. https://doi.org/10.1016/j.matdes.2016.10.025.
[2] Liu X, Lan S, Ni J. Analysis of process parameters effects on friction stir welding of dissimilar aluminum alloy to advanced high strength steel. Mater Des 2014; 59:50-62. https://doi.org/10.1016/j.matdes.2014.02.003.
[3] Oliveira J P, Ponder K, Brizes E, Abke T, Edwards P, Ramirez A J. Combining resistance spot welding and friction element welding for dissimilar joining of aluminum to high strength steels. J Mater Process Technol 2019; 273:116192. https://doi.org/10.1016/j.jmatprotec.2019.04.018.
[4] Tanaka T, Nezu M, Uchida S, Hirata T. Mechanism of intermetallic compound formation during the dissimilar friction stir welding of aluminum and steel. J Mater Sci 2020; 55:3064-72. https://doi.org/10.1007/s10853-019-04106-2.
[5] Chen S, Daehn G S, Vivek A, Liu B, Hansen S R, Huang J, et al. Interfacial microstructures and mechanical property of vaporizing foil actuator welding of aluminum alloy to steel. Mater Sci Eng A 2016; 659:12-21. https://doi.org/10.1016/j.msea.2016.02.040.
[6] Wan Z, Wang H P, Chen N, Wang M, Carlson B E. Characterization of intermetallic compound at the interfaces of Al-steel resistance spot welds. J Mater Process Technol 2017; 242:12-23. https://doi.org/10.1016/j.jmatprotec.2016.11.017.
[7] Oikawa H, Ohmiya S, Yoshimura T, Saitoh T. Resistance spot welding of steel and aluminium sheet using insert metal sheet. Sci Technol Weld Join 1999; 4:80-8. https://doi.org/10.1179/136217199101537608.
[8] Ibrahim I, Uematsu Y, Kakiuchi T, Tozaki Y, Mizutani Y. Fatigue behaviour of dissimilar Al alloy/galvanised steel friction stir spot welds fabricated by scroll grooved tool without probe 2015; 20:670-9. https://doi.org/10.1179/1362171815Y.0000000053.
[9] Sun Y F, Fujii H, Takaki N, Okitsu Y. Microstructure and mechanical properties of dissimilar Al alloy/steel joints prepared by a flat spot friction stir welding technique. Mater Des 2013; 47:350-7. https://doi.org/10.1016/j.matdes.2012.12.007.
[10] Miyamoto K, Nakagawa S, Sugi C, Sakurai H, Hirose A. Dissimilar Joining of Aluminum Alloy and Steel by Resistance Spot Welding. SAE Int J Mater Manuf 2009; 2:2009-01-0034. https://doi.org/10.4271/2009-01-0034.
[11] Zhang W, Sun D, Han L, Liu D. Interfacial microstructure and mechanical property of resistance spot welded joint of high strength steel and aluminium alloy with 4047 AlSi₁₂ interlayer. Mater Des 2014; 57:186-94. https://doi.org/10.1016/j.matdes.2013.12.045.
[12] Lu Y, Mayton E, Song H, Kimchi M, Zhang W. Dissimilar metal joining of aluminum to steel by ultrasonic plus resistance spot welding—Microstructure and mechanical properties. Mater Des 2019; 165:107585. https://doi.org/10.1016/j.matdes.2019.107585.
[13] Lu Y, Walker L, Kimchi M, Zhang W. Microstructure and Strength of Ultrasonic Plus Resistance Spot Welded Aluminum Alloy to Coated Press Hardened Boron Steel. Metall Mater Trans A Phys Metall Mater Sci 2020; 51:93-8. https://doi.org/10.1007/s11661-019-05524-2.
[14] Ibrahim I, Ito R, Kakiuchi T, Uematsu Y, Yun K, Matsuda C. Fatigue behaviour of Al/steel dissimilar resistance spot welds fabricated using Al—Mg interlayer. Sci Technol Weld Join 2016; 21:223-33. https://doi.org/10.1179/1362171815Y.0000000086.
[15] Yin F C, Zhao M X, Liu Y X, Han W, Li Z. Effect of Si on growth kinetics of intermetallic compounds during reaction between solid iron and molten aluminum. Trans Nonferrous Met Soc China (English Ed 2013; 23:556-61. https://doi.org/10.1016/S1003-6326(13)62499-1.
[16] Cheng W J, Wang C J. Microstructural evolution of intermetallic layer in hot-dipped aluminide mild steel with silicon addition. Surf Coatings Technol 2011; 205:4726-31. https://doi.org/10.1016/j.surfcoat.2011.04.061.
[17] Cheng W J, Wang C J. Effect of silicon on the formation of intermetallic phases in aluminide coating on mild steel. Intermetallics 2011; 19:1455-60. https://doi.org/10.1016/j.intermet.2011.05.013.
[18] Cheng W J, Wang C J. Effect of chromium on the formation of intermetallic phases in hot-dipped aluminide Cr—Mo steels. Appl Surf Sci 2013; 277:139-45. https://doi.org/10.1016/j.apsusc.2013.04.015.
[19] Yousaf M, Iqbal J, Ajmal M. Variables affecting growth and morphology of the intermetallic layer (Fe₂Al₅). Mater Charact 2011; 62:517-25. https://doi.org/10.1016/j.matchar.2011.03.004.
[20] Nielsen C V., Zhang W, Alves L M, Bay N, Martins P A F. Modeling of Thermo-Electro-Mechanical Manufacturing Processes with Applications in Metal Forming and Resistance Welding. 2013. https://doi.org/10.1007/978-1-4471-4643-8_1.
[21] Zhang W. Recent advances and improvements in the simulation of resistance welding processes. Weld World 2006; 50:29-37. https://doi.org/10.1007/BF03263430.
[22] Akdeniz M V., Mekhrabov A O. The effect of substitutional impurities on the evolution of Fe—Al diffusion layer. Acta Mater 1998; 46:1185-92. https://doi.org/10.1016/S1359-6454(97)00318-2.
[23] Dangi B, Brown T W, Kulkarni K N. Effect of silicon, manganese and nickel present in iron on the intermetallic growth at iron-aluminum alloy interface. J Alloys Compd 2018; 769:777-87. https://doi.org/10.1016/j.jallcom.2018.07.364.
[24] Lippold J C, Sowards J W, Murray G M, Alexandrov B T, Ramirez A J. Weld solidification cracking in solid-solution strengthened ni-base filler metals. Hot Crack Phenom Welds II 2008:147-70. https://doi.org/10.1007/978-3-540-78628-3_9.
[25] Školáková A, Salvetr P, Leitner J, Lovaśi T, Novák P. Formation of Phases in Reactively Sintered TiAl3 Alloy. Molecules 2020; 25:1912. https://doi.org/10.3390/molecules25081912.
[26] Garrison W M. Steels: Classifications. Encycl. Mater. Sci. Technol., Elsevier; 2001, p. 8840-3. https://doi.org/10.1016/B0-08-043152-6/01587-4.
[27] Qiu R, Iwamoto C, Satonaka S. Interfacial microstructure and strength of steel/aluminum alloy joints welded by resistance spot welding with cover plate. J Mater Process Technol 2009; 209:4186-93. https://doi.org/10.1016/j.jmatprotec.2008.11.003.
[28] Dybkov V I. Interaction of 18Cr-10Ni stainless steel with liquid aluminium. J Mater Sci 25 1990; 25:3615-33.
[29] Mirza F A, Macwan A, Bhole S D, Chen D L, Chen X G. Effect of welding energy on microstructure and strength of ultrasonic spot welded dissimilar joints of aluminum to steel sheets. Mater Sci Eng A 2016; 668:73-85. https://doi.org/10.1016/j.msea.2016.05.040.

### Example 2

The automotive industry has been exploring the application of next-generation advanced high strength steel (AHSS) within multi-material joints in recent Body-In-White designs. Such combinations align with the industry goals to reduce vehicle weight for increased fuel efficiency and reduced carbon emissions.

The introduction of advanced materials, e.g. alloying additions and coatings, to body-in-white designs has hindered resistance spot welding joining. Adequate performance should be achieved with minimal modification to the existing capital assets and production routes in Original Equipment Manufacturer (OEM) assembly facilities.

Specific challenges arise when considering the RSW of dissimilar joints, e.g. Al/AHSS joints, such as electrical/thermal conductivity, crystal structures, melting points, and intermetallic compounds.

Due to iron's low solubility in aluminum, a thick and brittle intermetallic compound (IMC) layer can form at the fusion weld interface. The intermetallic compound layer results from a reaction between Al and Fe and serves as the bond between the two materials. If not well controlled (distribution and morphology), it deteriorates the weld's load-bearing capacity due to the brittle nature of the IMC layer.

To control the Al—Fe intermetallic formation, several authors have been placing an insert (also referred to as interlayer or transition material) between the Al and steel sheets. The interlayer's purpose is to provide a controlled transition between aluminum and steel, avoiding/mitigating the undesirable Al—Fe IMC formation. The current interlayer applications in the RSW process are thin foils, hot-dipping, cladding, and thermal spray.

Herein, the use of interlayer technologies to facilitate resistance spot welting of AL/AHSS and AHSS/AHSS joints is explored. There are two main parts, namely steel-steel resistance spot welding and Al-steel RSQ, each having their own challenges.

The motivation behind this exploration is to achieve minimal modification to existing capital assets and production routes in OEM assembly facilities. The concept involves application of interlayers to an area of sheet metal (FIG. 16) that minimally affects the substrate metal during application, provides layer thickness control, and withstands manufacturing steps prior to welding. The interlayer is applied as a preprocessing step before entering an OEM assembly facility.

The methodology involved three main parts: interlayer exploration (e.g., FeₓAlₓ inhibitors), mechanical performance testing (e.g., foil placing, foil-UMW, and AM (L-PBF) interlayer), and joint characterization (e.g., IMC layer).

Interlayer candidates were explored to control the intermetallic layer formation and improve the mechanical properties of AHSS to Al 6022 resistance spot welds. An in-depth investigation of the Al activity and diffusivity properties for several materials combinations was performed using a CalPhaD analysis in order to select the elements with the most impact in the intermetallic formation.

Later, the selected material interlayer was resistance spot welded and its characteristics evaluated. Lastly, electron microscopy and mechanical testing were used to evaluate the joints characteristics.

Spot welding was conducted using a Medium Frequency Direct Current (MFDC) resistance spot welder equipped with a servo-driven force system available at the Edison Joining Technology Center.

The base materials were a 2 mm-6022-T4 Aluminum alloy and a 1.6 mm-AHSS (USIBOR® 2000—Provided by ArcelorMittal) (e.g., AlSi coated hot-stamped steel). The chemical composition of the base metals is shown in Table 4.

TABLE 4
Chemical composition of the base metals.

| | Max | Max | Max | Max | Max | Max | Max | Max | Max | Max |
|---|---|---|---|---|---|---|---|---|---|---|
| # | Al | C | Si | Mg | Mn | Cr | Mo | B | Ni | Fe |
| Usibor | — | 0.37 | 0.7 | — | 1.4 | 0.7 | 0.7 | 0.005 | 0.35 | Bal |
| 2000 ® | | | | | | | | | | |
| 6022-T4 | Bal | 0.8 | 0.6 | 0.1 | 0.03 | — | — | — | — | — |

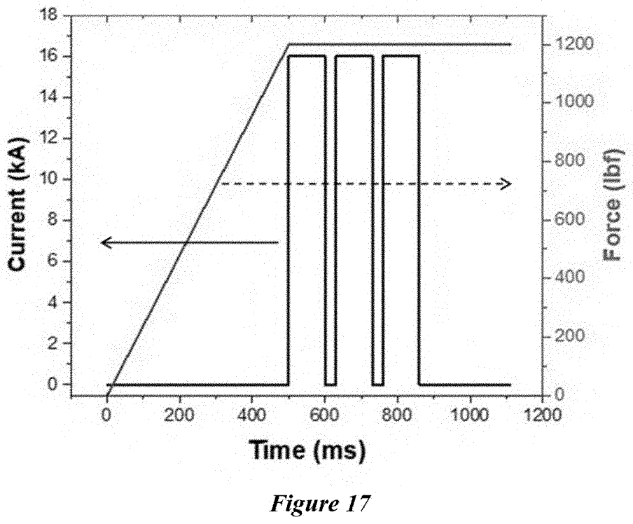

The following spot welding multi-stack setup was performed for all experiments: 6022 Aluminum alloy, interlayer, and AHSS. Facing the Al sheet was a F-type, flat electrode with a 16 mm face diameter and a 75 mm radius; facing the steel sheet was a B-type, dome-shaped electrode. Details can be seen in FIG. 1. The welding variables are shown in Table 5. The weld current was 3 P-16 kA, the weld time was 166 ms, and the weld force was 1200 lbf, as shown in FIG. 17.

TABLE 5
Welding variables.

| | Electrode | | Electrode |
|---|---|---|---|
| Material | Geometry | Electrode Tip | Composition |
| Usibor 2000 ® | B-Type | 8.0 mm | CuCrZr |
| 6022-T4 | F-Type | 19.0 mm | CuCrZr |

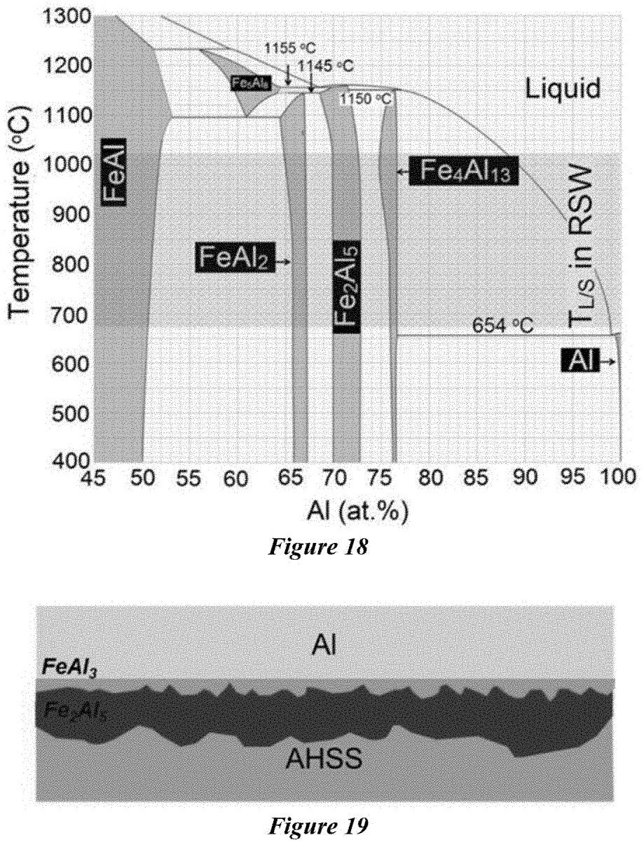

In the absence of any interlayer, intermetallic compounds form during resistance spot welding between Al and AHSS (FIG. 18). For example, FeAl₃ (and/or Fe₄Al₁₃) intermetallics with a thickness<0.5 μm and a Fe₂Al₅ intermetallic with a thickness of 1-2 μm can form (FIG. 19).

The formation of FeₓAlₓ intermetallics can be inhibited via a reduction in the activity coefficient of the Al atoms (γ_{Al}). The effect of various impurity elements (e.g., Si, Cr, Ti, Ge, Sb, Mg, Cu, Ca, Ag, and Cd) on the evolution of an Fe—Al diffusion layer has previously been investigated (Akdeniz et al. Acta Mater., 1998, 46).

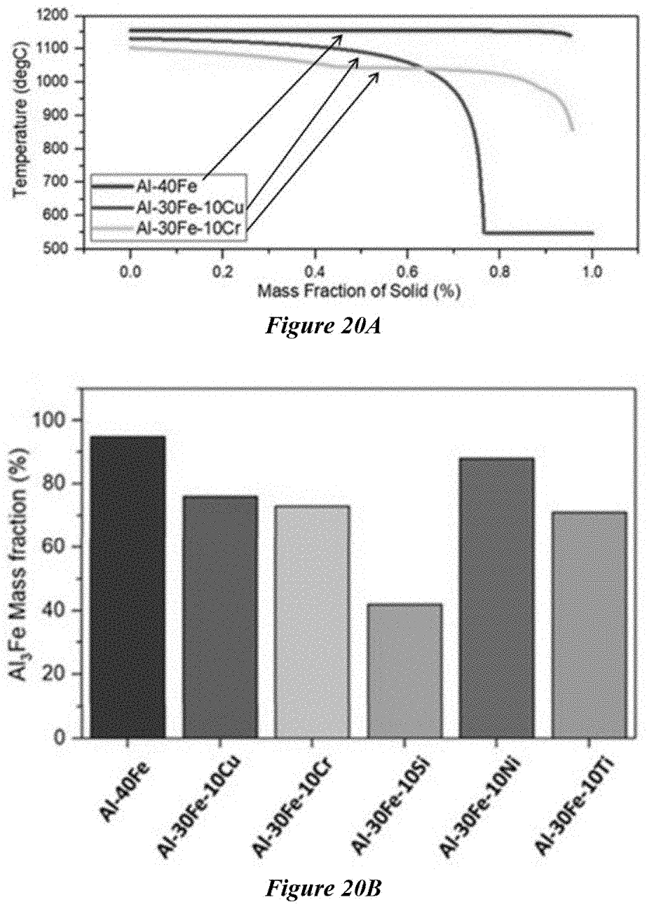

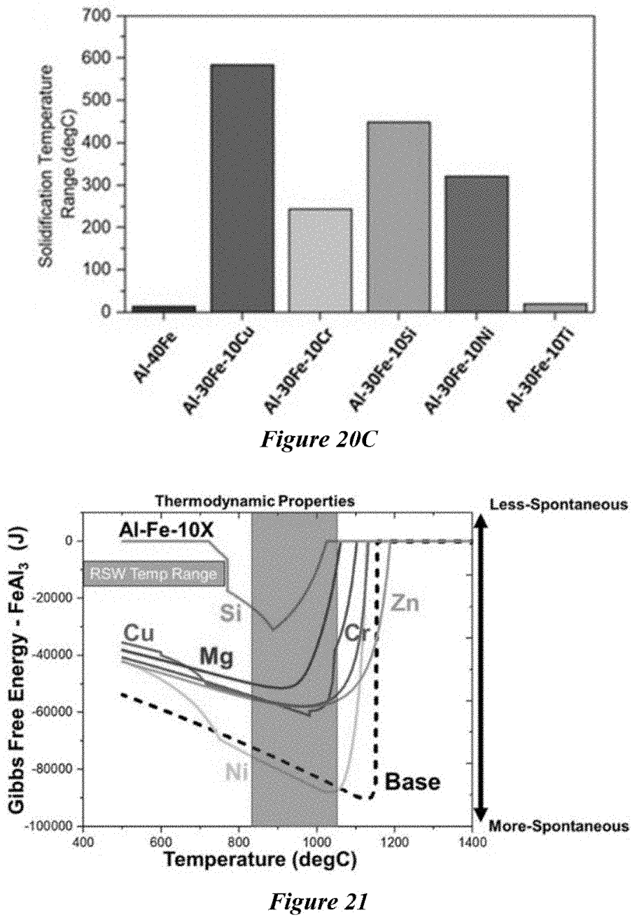

The goal of adding secondary elements to the Al—Fe system is to mitigate/reduce the IMC and not compromise other weld-related conditions, such as solidification cracking. Computational thermodynamic or coupled thermodynamic-kinetic models are often used to assess solidus temperature depression that can act as indicators for solidification cracking behavior. Solidification cracking occurs in metals when intergranular liquid films rupture within the semisolid region that forms as solidification progresses. The longer the liquid phase, the higher is the alloy's cracking susceptibility. A common approach for this type of analysis is to use the Calphad method coupled with solidification models to evaluate the non-equilibrium solidification temperature range (STR) of materials. In FIG. 20A, an example of solidification profile for A-40Fe (baseline), Al-30Fe-10Cu and Al-30Fe-10Cr is presented. It is observed that Cu extends the liquid-solid temperature range compared to Cr and the baseline (FIG. 20A-FIG. 20C). In a welding scenario, such composition would probably suffer from severe solidification cracking problems.

The solidification temperature range and amount of Al₃Fe present at the end of the solidification for six elements (Si, Cr, Cu, Mg, Zn, and Ni) were evaluated. The effect of the elements on FeAl₃ Gibbs Free Energy is shown in FIG. 21.

All elements explored could reduce the amount of Al₃Fe during solidification, with Ni being the least effective compared to others. Cu, Si, and Ni extended the liquid phase significantly, increasing the solidification cracking susceptibility. Although Ti presents a rapid liquid decomposition, the pair Al—Ti is known for its exothermic reaction during heating, disturbing the determined RSW parameters approach for this study.

A diffusion study was also performed to evaluate the effects of interlayer composition on IMC growth, as seen in FIG. 5. The conditions set was the left border providing Al to the Fe—X system, presenting 2.5 μm in length. The temperature and time set was 950° C. for 0.6 seconds. The results indicate that, compared to the baseline (100% Fe matrix), the addition of 10% Cr and Si were able to reduce the Al diffusion through the Fe matrix. A minor influence was observed using Ni, as demonstrated by Akdeniz et al. Si and Cr have the largest impact in reducing Al diffusion in the system, because Si and Cr atoms can occupy vacancies in the c-axis of the orthorhombic Fe₂Al₅ compound (Yin et al. Transactions of Nonferrous Metals Society of China (English Edition), 2013, 23(2). 556-561).

Despite reducing the amount of intermetallic generated, high contents of Si in steels are considered detrimental. Embrittlement (loss of a material's ductility) is observed when the silicon additions on steels exceed about 2 wt. %.

Cr, however, usually does not promotes steel issues, as observed in stainless steels containing 18 to 30% Cr in weight. The analysis presented by Qin et al. in RSW and Dybkov in Al hot dipping reveals that a small quantity of Cr and Ni are contained in the Al—Fe phases. Reaction products are solid solutions based on Al₃Fe and Al₅Fe₂ and expressed as Al₃(Fe, Cr, Ni) and Al₅(Fe, Cr, Ni)₂. In that way, Cr has shown the highest potential to reduce the Al—Fe IMC formation following the established criteria without significant drawbacks.

Several methods were considered to add Cr as an interlayer: foils, coating, and laser deposition.

To investigate foils interlayers, 300-micron thick foil interlayers were applied. As pure-Cr foils are not widely available due to their expensive cost, interlayer alloys containing high Cr content were chosen as candidates: 430 Stainless steel (SS) containing 16% Cr, 304 Stainless Steel, a standard “18/8” (Cr/Ni) stainless, and EBrite Stainless steel, a super ferritic stainless steel containing up to 27% Cr in its composition. Ni's presence on 304 will also be evaluated and compared to the results present in the previous section. Low carbon steel foils were also used for comparison purposes. The composition of each interlayer is presented in Table 6.

TABLE 6
Interlayer compositions

| Alloy | C | Cr | Ni | Si | Mn | Al | Fe |
|---|---|---|---|---|---|---|---|
| Low Carbon Steel | 0.09 | 0.03 | 0.01 | 0.009 | 0.35 | — | Bal |
| 430 Stainless Steel | 0.09 | 17 | 0.05 | 0.05 | 1 | — | Bal |
| 304 Stainless Steel | 0.08 | 18.5 | 9 | 0.05 | 1 | — | Bal |
| EBrite Stainless Steel | 0.01 | 27.5 | 0.5 | 0.4 | 0.4 | — | Bal |
| (ASTM XM-27) | | | | | | | |

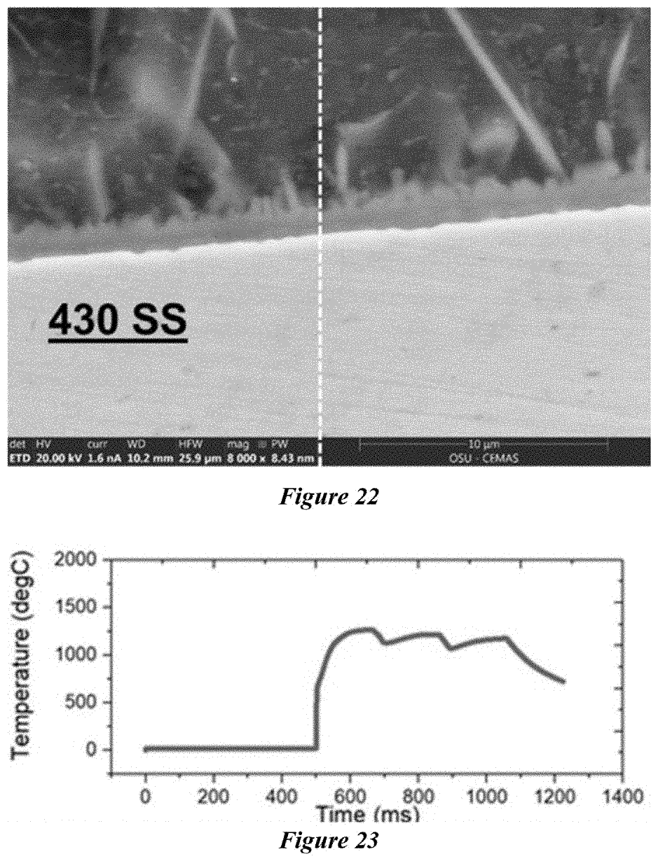

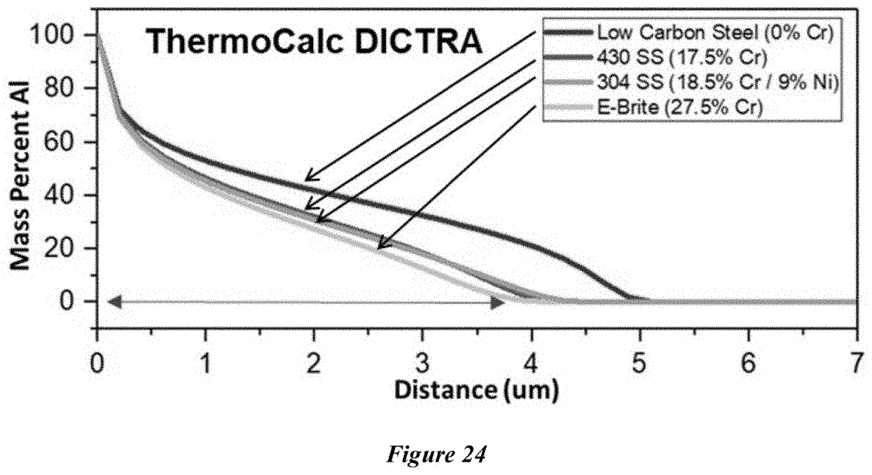

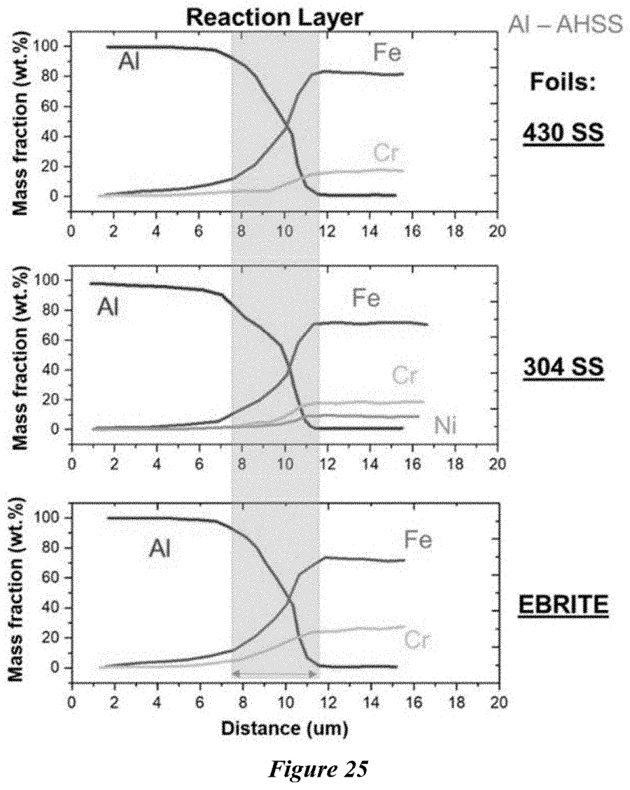

The effect of the compound of chromium on the IMC thickness for the various interlayers was investigated. An SEM image of the 430 SS interlayer interface is shown in FIG. 22. SORPAS thermal history is shown in FIG. 23. FIG. 24 is the simulated Al diffusion through different alloys.

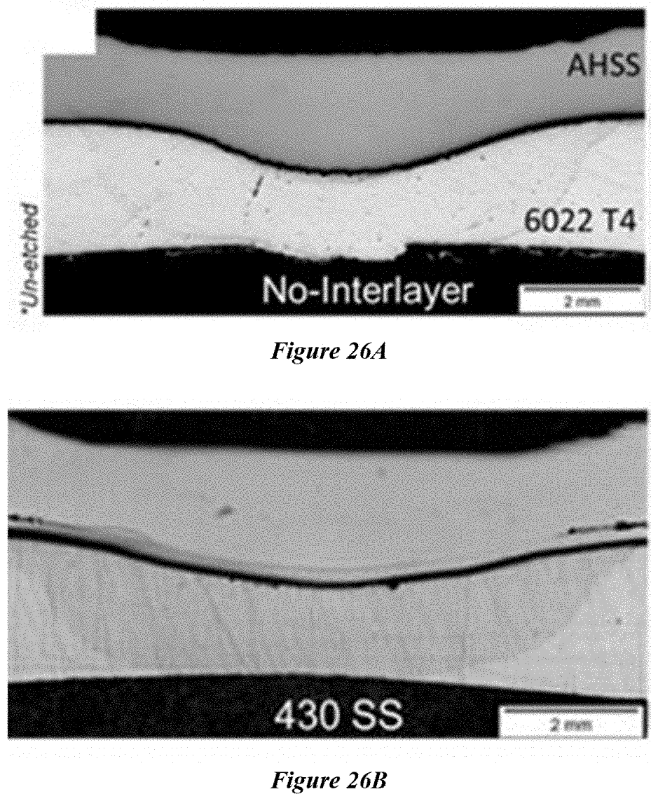

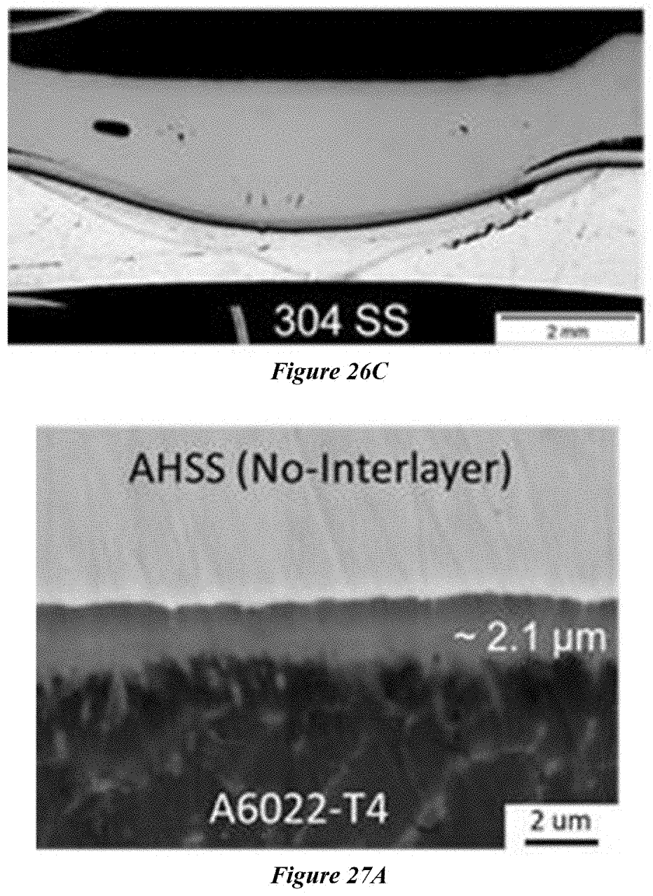

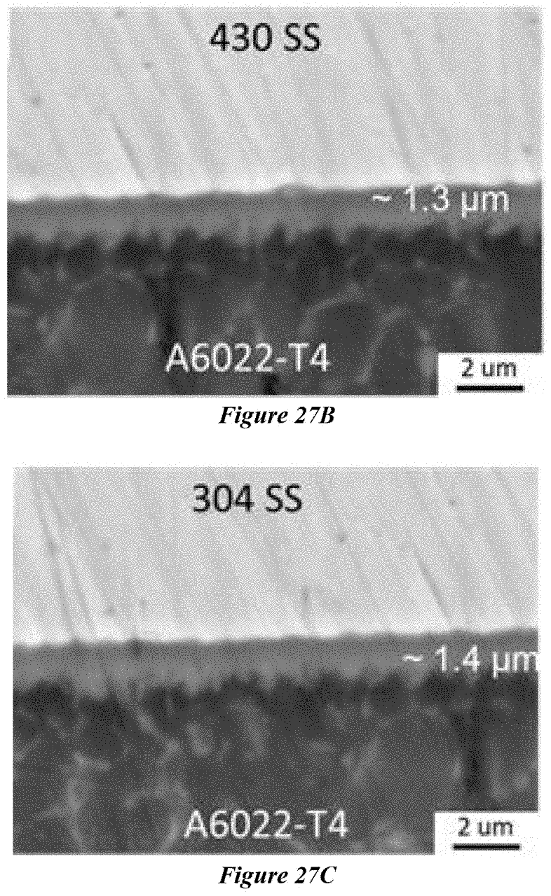

For the interlayer trials with various stainless steel foils, direct foil placement with a foil thickness of 250 μm were used. Cross-sections of Al-Interlayer-AHSS welds are presented in FIG. 26A-FIG. 26C. Visually, no significant difference between joints is observed. All welds share a similar characteristic: two nuggets on base materials separated by an unmelted interface. The first nugget was formed at the Al, featuring molten Al nugget spread on the interlayer. The second nugget was formed inside the base AHSS sheet. As no nugget was formed between materials, a “nugget diameter” was defined by the Al nugget. According to the mentioned criteria, the diameter varied between 9.2 and 9.4 mm. In FIG. 27A-FIG. 27C, the Al-interlayer interface between materials is presented.

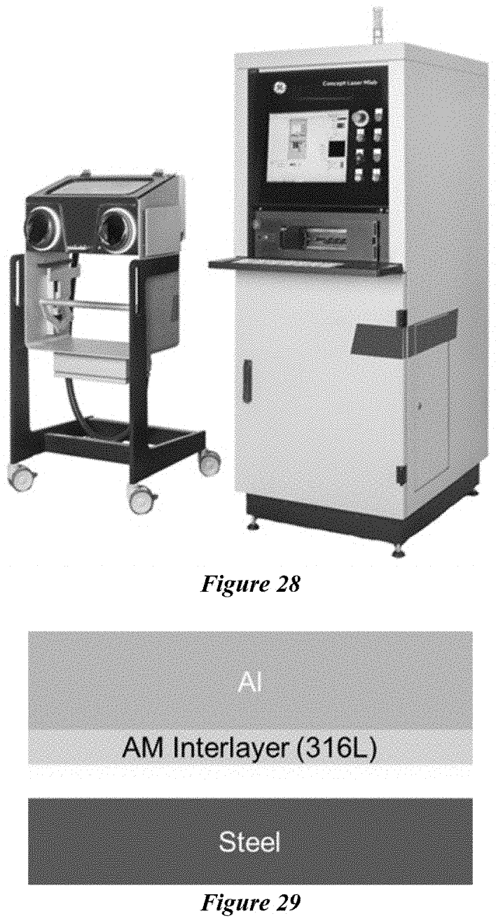

The laser deposition method uses additive manufacturing (AM) for forming the interlayer. For these experiments, a GE concept laser M-lab Cusing 500R machine with a 100 W (cw) diber laser was used (FIG. 28). The machine limited the spaced for the coupon size. A print volume of 90 mm×90 mm×80 mm (x, y, z) and a sample size of 150 mm×50 mm were used.

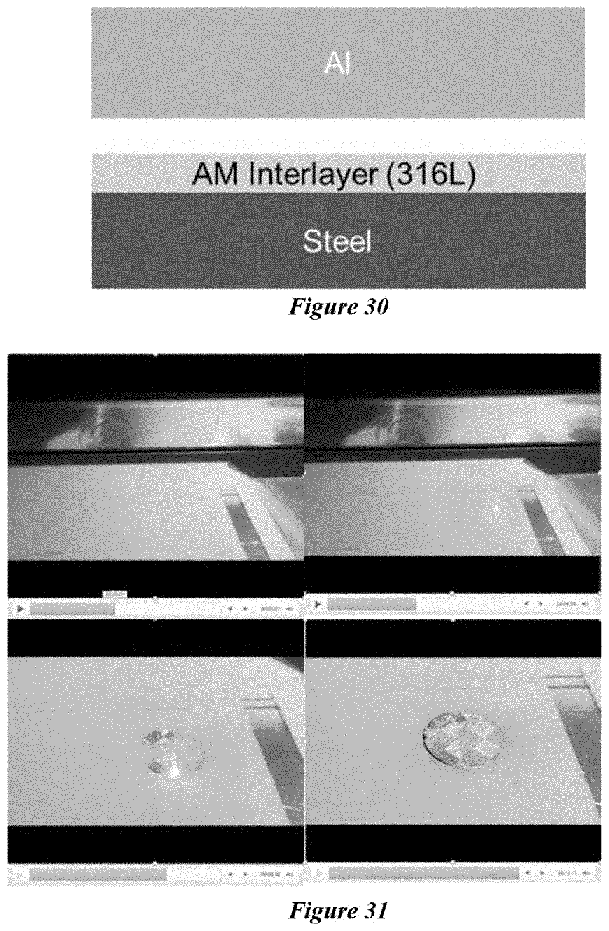

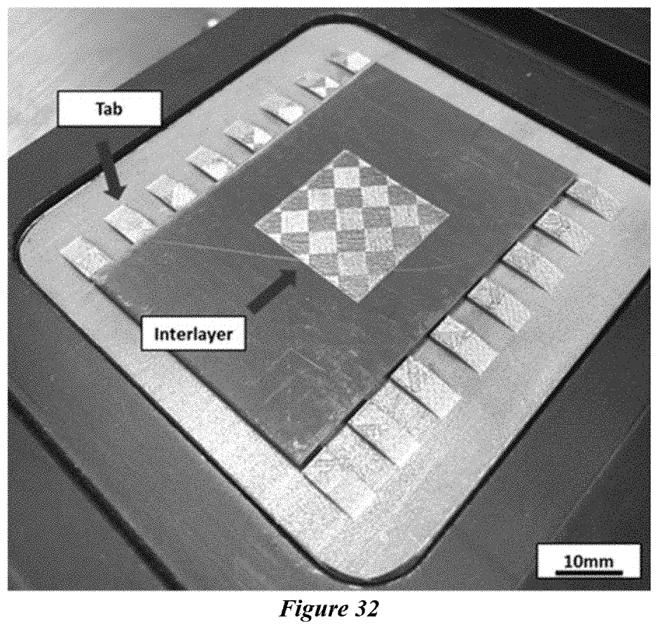

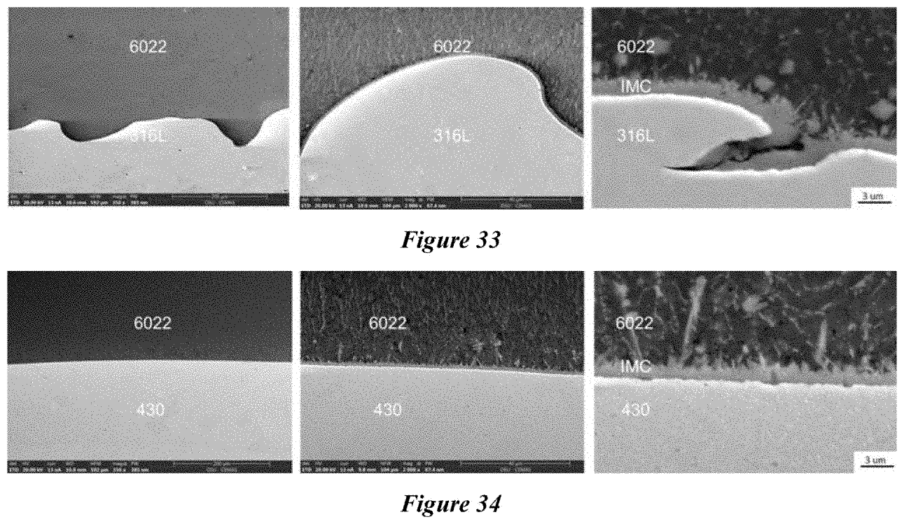

AM shows a lower heat input compared to RSW. In one set of experiments, the interlayer was printed on to the Al base layer to avoid intermetallic formation (FIG. 29). In another set of experiments, the interlayer was printed on to the AHSS base layer, which presented no deposition issues (FIG. 30). Due to challenges presented in printing on to the Al base layer, printing onto the AHSS was selected as the best approach. Images of the AM interlayer printing are shown in FIG. 31. An image of a printed AM interlayer is shown in FIG. 32. The deposition profile of the 316L interlayer printed using additive manufacturing (FIG. 33) was compared with a 430 foil interlayer (FIG. 34). As can be seen by comparing FIG. 33 and FIG. 34, the foil interlayer provided a smoother interface.

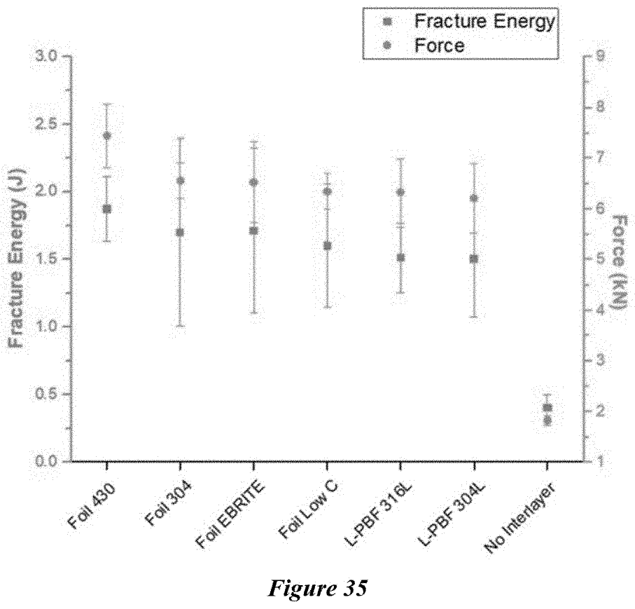

Mechanical tests were performed to evaluate the effect of the foil interlayer materials on the resistance spot welds performance. The mechanical performance of welds was evaluated by lap-shear tensile testing. Under the same welding condition, Al/steel dissimilar welds with interlayer exhibited higher tensile shear force than those without interlayer (FIG. 35). The observed nugget diameters are summarized in Table 7.

TABLE 7
Nugget diameter.

| Interlayer (wt % Cr, Ni) | Nugget Diameter-Al |
|---|---|
| Foil 430 (16-18, 0-0.7) | 9.3 mm |
| Foil 304 (16-18, 10-14) | 9.3 mm |
| Foil EBRITE (25-27, 8-10) | 9.6 mm |
| Foil Low C | 9.6 mm |
| L-PBF 316L (16-18, 10-14) | 8.3 mm |
| L-PBF 304L (16-18, 10-14) | 8.5 mm |
| No Interlayer | 8.7 mm |

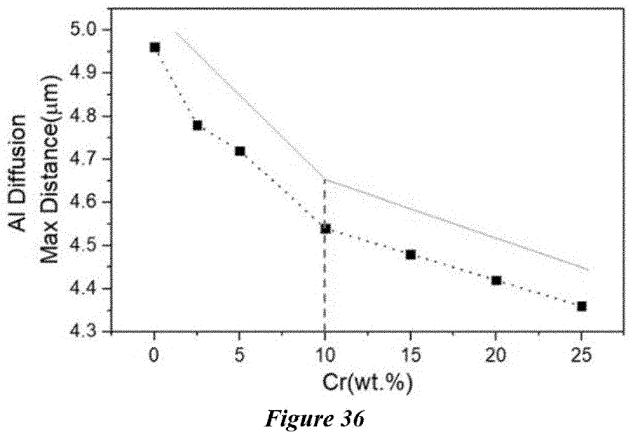

Results for interlayers with different amounts of Cr is shown in FIG. 36. In general, the results herein indicate that >10 wt % Cr has minimal effects on mechanical performance and IMC thickness.

Thermal profiles were obtained through numerical simulations using SORPAS software, as seen in FIG. 7. The presence of an interlayer increases interface temperature alloying for lower currents used. The presence of interlayers increases the number of contact resistances on the welded sample, which promotes higher temperatures than an no-interlayer weld, during the resistance spot welding. Such response enables parameters selection for interlayer weld with shorter times to achieve the same heat input as the ones observed on no-interlayer welds.

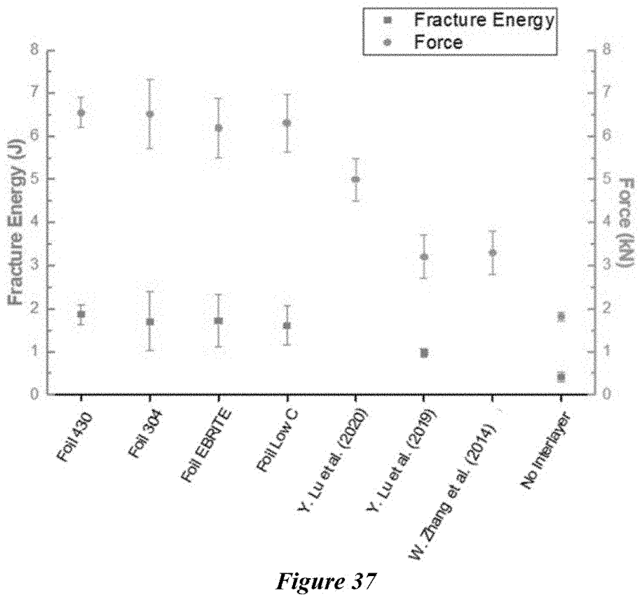

A comparison of the results herein with literature results are shown in FIG. 37 and Table 8. Joint efficiency was based on the following equations:

$${δ}_{IF} = \frac{F}{π {r}^{2} {σ}_{Al}} \\ {δ}_{BP} = \frac{F}{2 π r {σ}_{Al}} \\ {E}_{W} = \frac{{δ}_{BP} or {δ}_{IF}}{{UTS}_{Al}}$$

TABLE 8
Literature Comparison.

| | | | Nugget | Peak | | Joint | |
|---|---|---|---|---|---|---|---|
| | | | Diameter | Load | Failure | Efficiency | |
| Al | Steel | Interlayer | (mm) | (kN) | Mode | (E_{w} %) | Ref |
| 1.5 mmt | 1.0 mmt GI | — | 5.8 | 3.3 | IF | 37% | W. Zhang |
| 6008-T66 | Coated | | | | | | (2014) |
| | H220YD | | | | | | |
| 1.0 mmt | 0.9 mmt Low | 6061-T6 | 5.4 | 3.2 | BP | 61% | Y. Lu |
| 6061-T6 | Carbon Steel | | | | | | (2019) |
| 1.2 mmt | 1.4 mmt | 316 SS | 7.7 | 5 | BP | 51% | Y. Lu |
| 6022-T4 | Usibor ® 1500 | | | | | | (2020) |
| 2.0 mmt | 1.6 mmt | 304 SS | 9.3 | 6.5 | IF | 44% | Present |
| 6022-T4 | Usibor ® 2000 | | | | | | work |
| 2.0 mmt | 1.6 mmt | Low C | 9.6 | 6.3 | IF | 40% | Present |
| 6022-T4 | Usibor ® 2000 | | | | | | work |
| 2.0 mmt | 1.6 mmt | 430 SS | 9.3 | 6.5 | IF | 44% | Present |
| 6022-T4 | Usibor ® 2000 | | | | | | work |
| 2.0 mmt | 1.6 mmt | EBRITE | 9.6 | 6.1 | IF | 38% | Present |
| 6022-T4 | Usibor ® 2000 | | | | | | work |

Additional methods considered to add Cr as an interlayer include electroplating (e.g., on base Al, on low carbon steel foil), cold spray (e.g., on base Al), and powder bed (AM) (e.g., 430, 316, and 304 powder).

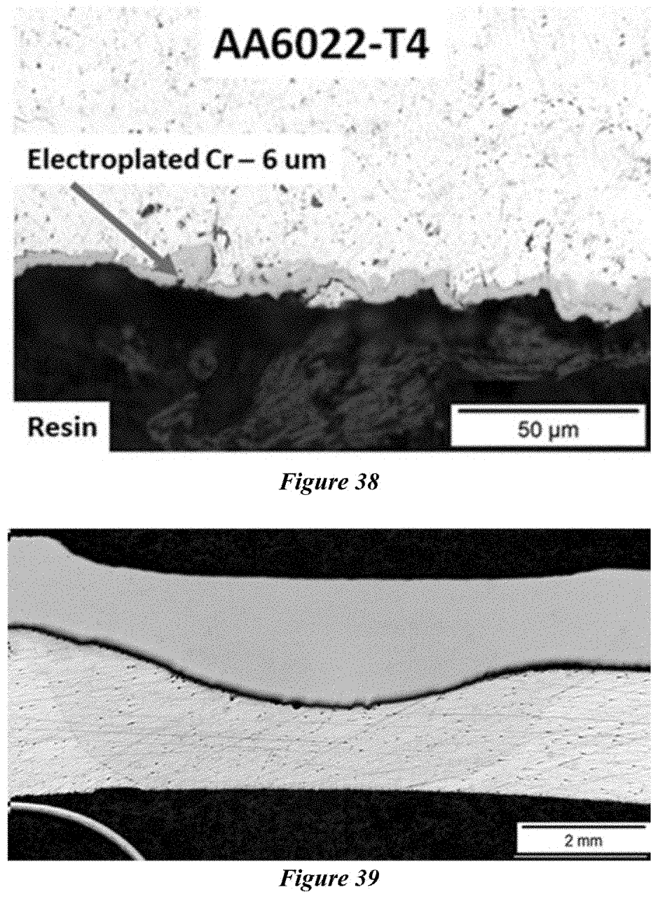

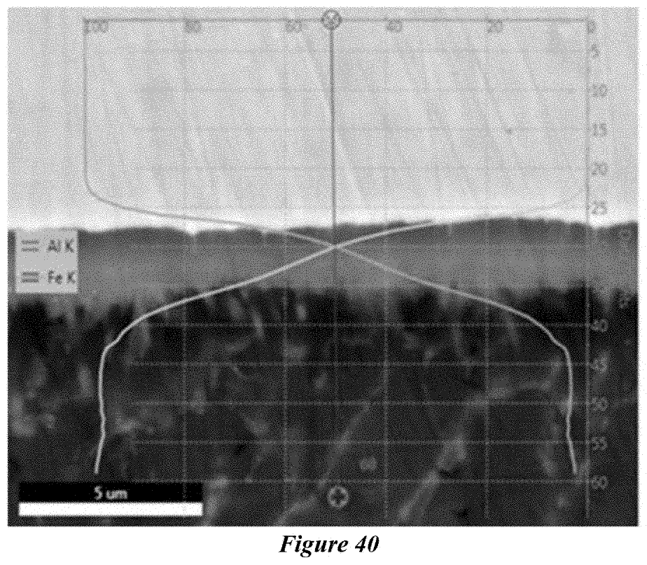

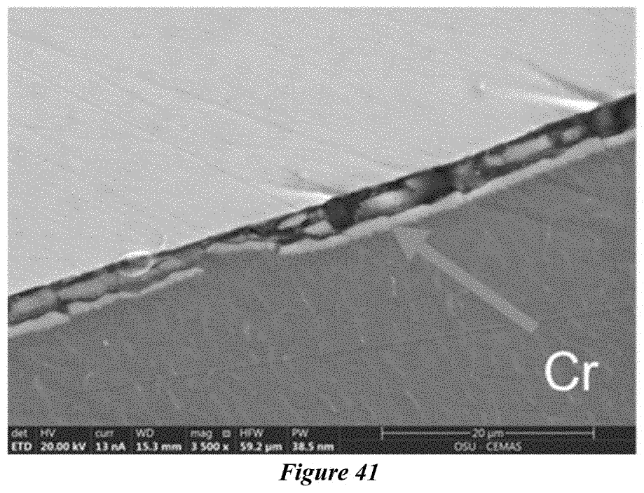

Preliminary results from electroplating on base Al are shown in FIG. 38-FIG. 41. No Cr was found on the weld center. Cr appears near to the edges. Cr layer may be removed from weld center/need higher Cr thicknesses.

Additionally, Si and Zn are being explored via the use of AA4032 (10% Si) and galvanized low carbon steel foils.

### Example 3

The automotive industry has been exploring the application of next-generation advanced high strength steel (AHSS) within multi-material joints in recent Body-In-White designs.

Due to iron's low solubility in aluminum, a thick and brittle intermetallic compound (IMC) layer can form at the fusion weld interface. The intermetallic compound layer results from a reaction between Al and Fe and serves as the bond between the two materials [6,7]. If not well controlled (distribution and morphology), it deteriorates the weld's load-bearing capacity, this is because the brittle nature of the IMC layer [8, 9].

To control the Al—Fe intermetallic formation, several authors have been placing an insert (also referred to as interlayer or transition material) between the Al and steel sheets [11-14]. The interlayer's purpose is to provide a controlled transition between aluminum and steel, avoiding/mitigating the undesirable Al—Fe IMC formation. The current interlayer applications in the RSW process are thin foils, hot-dipping, cladding, and thermal spray [7, 12].

Describes herein are methods comprising applying Cr-rich interlayer (such as Pure Cr, electroplated Cr coating, ferritic stainless steels, and Cr containing structural C-steels) between the Aluminum alloy and the steel plates before resistance spot welding and other joining processes that can induce intermetallic phases formation by the direct interaction of the Al and the Fe on the Al-alloy and steel, respectively.

In-house advanced materials modeling and experimental studies have shown that Chromium can preclude or reduce the formation of brittle Al—Fe intermetallic phases, which are form during joining processes like resistance spot welding. This expands the joining processes parameter window and dramatically improves the joint strength, ductility, and toughness. Pure Cr and Cr rich alloys allow deploying the interlayer technology focusing on the chemical elements that play a relevant role in preventing intermetallic phase formation.

No significant drawbacks have been observed, such as increasing solidification cracking susceptibility and secondary intermetallic phase formation.

Cr-alloyed interlayers' use provides better mechanical performance compared to scenarios without any interlayer or interlayers based on other alloys or elements.

This method builds on previous work around the world that has used other materials like Austenitic stainless steels 304 or 316 for this same purpose. However, previous work was quite empirical and did not address the fundamentals of the phenomena to tailor composition to maximize response while minimizing cost.

The results described herein based on in-house development narrowed down both composition and processes, focusing on the most effective ones.

The mechanical performance revealed the beneficial effect of Cr (FIG. 35). However, the Cr content variations between the stainless steel alloys did not result in mechanical performance differences. The results suggest that values between 17-25% Cr provide similar benefits in mechanical performance (threshold). The foil method also provided better results compared to other types of depositions methods (FIG. 35). Most studies point Ni as a candidate. The findings herein show that Ni is irrelevant for the present application.

Other advantages which are obvious and which are inherent to the invention will be evident to one skilled in the art. It will be understood that certain features and sub-combinations are of utility and may be employed without reference to other features and sub-combinations. This is contemplated by and is within the scope of the claims. Since many possible embodiments may be made of the invention without departing from the scope thereof, it is to be understood that all matter herein set forth or shown in the accompanying drawings is to be interpreted as illustrative and not in a limiting sense.

The methods of the appended claims are not limited in scope by the specific methods described herein, which are intended as illustrations of a few aspects of the claims and any methods that are functionally equivalent are intended to fall within the scope of the claims. Various modifications of the methods in addition to those shown and described herein are intended to fall within the scope of the appended claims. Further, while only certain representative method steps disclosed herein are specifically described, other combinations of the method steps also are intended to fall within the scope of the appended claims, even if not specifically recited. Thus, a combination of steps, elements, components, or constituents may be explicitly mentioned herein or less, however, other combinations of steps, elements, components, and constituents are included, even though not explicitly stated.

What is claimed is:

1. A method of resistance spot welding or brazing an aluminum member to a steel member, the aluminum member and the steel member each having a first surface, the method comprising:
forming a workpiece stack by disposing a chromium layer having a first surface and a second surface opposite and spaced apart from the first surface between the aluminum member and the steel member, such that:
at least a portion of the first surface of the aluminum member is in physical contact with the first surface of the chromium layer; and
at least a portion of the first surface of the steel member is in physical contact with the second surface of chromium layer; and
resistance spot welding or brazing the workpiece stack together;
wherein the chromium layer comprises chromium in an amount of from 1 wt. % to 30 wt. %.

2. The method of claim 1, wherein the aluminum member comprises an aluminum alloy.

3. The method of claim 1, wherein the steel member comprises an advanced high strength steel (AHSS).

4. The method of claim 1, wherein the aluminum member, the steel member, or a combination thereof comprises at least a portion of a vehicle, heat exchanger, pipe, or conduit.

5. The method of claim 1, wherein the chromium layer comprises chromium in an amount of from 1 wt. % to 17 wt. %.

6. The method of claim 1, wherein the chromium layer comprises chromium in an amount of from 10 wt. % to 26 wt. %.

7. The method of claim 1, wherein the chromium layer comprises a chromium alloy.

8. The method of claim 1, wherein the chromium layer comprises 430 stainless steel, 304 stainless steel, EBrite stainless steel, 316 stainless steel, austenic stainless steel, ferritic stainless steel, or a combination thereof.

9. The method of claim 1, wherein the chromium layer has an average thickness of from 100 μm to 500 μm.

10. The method of claim 1, wherein the chromium layer comprises a foil or sheet.

11. The method of claim 1, wherein the method further comprises depositing the chromium layer onto the portion of the second surface of the aluminum member, the portion of the first surface of the steel member, or a combination thereof.

12. The method of claim 1, wherein the method comprises resistance spot welding the workpiece stack together and resistance spot welding the workpiece stack together comprises:
contacting a first electrode with a location on a second surface of the aluminum member, the second surface of the aluminum member being opposite and spaced apart from the first surface;
contacting a second electrode with a location on a second surface of the steel member, the second surface of the steel member being opposite and spaced apart from the first surface;
wherein the location on the second surface of the aluminum member and the location on the second surface of the steel surface are aligned such that the first electrode is disposed opposite and spaced apart from the second electrode;
applying a current between the first electrode and the second electrode through the workpiece stack; and
terminating the application of current.

13. The method of claim 12, wherein the applied current is from 5 kilo Ampere (kA) to 25 kA; wherein the current is applied for an amount of time of from 50 milliseconds to 1000 milliseconds; or a combination thereof.

14. The method of claim 1, wherein the current is applied in a series of pulses, with each pulse independently having a length of from 66 milliseconds to 200 milliseconds, and wherein the series of pulses comprises two or more pulses.

15. The method of claim 1, wherein the method creates a weld or brazing joint that joins the workpiece stack together.

16. The method of claim 15, wherein the weld or brazing joint has improved mechanical performance relative to a weld or brazing joint formed from resistance spot welding or brazing a corresponding workpiece stack in the absence of the chromium layer.

17. The method of claim 15, wherein the weld or brazing joint has: a tensile shear force of 3 kiloNewtons (kN) or more; a fracture energy of 0.5 Joules (J) or more; or a combination thereof.

18. The method of claim 15, wherein the weld or brazing joint comprises an intermetallic compound layer with an average thickness of 3 μm or less or 2 μm or less.

19. The method of claim 15, wherein the intermetallic compound layer comprises Al₃Fe, Al₅Fe₂, or a combination thereof.

20. A workpiece stack configured for resistance spot welding or brazing, wherein the workpiece stack comprises:
an aluminum member having a first surface; a steel member having a first surface; and a chromium layer having a first surface and a second surface opposite and spaced apart from the first surface;
wherein the chromium layer is disposed between the aluminum member and the steel member, such that:
at least a portion of the first surface of the aluminum member is in physical contact with the first surface of the chromium layer; and
at least a portion of the first surface of the steel member is in physical contact with the second surface of chromium layer; and
wherein the chromium layer comprises chromium in an amount of from 1 wt. % to 30 wt. %.
